(19) United States
(12) Patent Application Publication
(10) Pub. No.: US 2025/0068820 A1
(43) Pub. Date: Feb. 27, 2025

(54) COMPUTER-READABLE RECORDING MEDIUM STORING MODULE TERMINAL DESIGN PROGRAM, MODULE TERMINAL DESIGN METHOD, AND INFORMATION PROCESSING DEVICE

(71) Applicant: Fujitsu Limited, Kawasaki-shi (JP)

(72) Inventors: Hideaki KATAGIRI, FUJISAWA (JP); Tomokazu NOMURA, Odawara (JP)

(73) Assignee: Fujitsu Limited, Kawasaki-shi (JP)

(21) Appl. No.: 18/782,062

(22) Filed: Jul. 24, 2024

(30) Foreign Application Priority Data
Aug. 21, 2023 (JP) 2023-134294

(51) Int. Cl. G06F 30/392

(52) U.S. Cl. CPC G06F 30/392

(57) ABSTRACT

A recording medium stores a module terminal design program for causing a computer to execute processing including: creating, for each placement position where a target macro that has a multilayer structure placed in a design target circuit is placeable according to a power supply structure of the design target circuit, a temporary macro that represents a placement pattern of terminals of each layer of the target macro; extracting, based on a result of comparison between placement patterns of the temporary macros, a common pattern; extracting a difference pattern that represents a difference from the extracted common pattern; registering the common pattern and the difference pattern; and creating, when the target macro is placed at any one placement position, a module terminal for a lifting target terminal in the target macro based on the common pattern and a difference pattern that corresponds to the any one placement position.

### CROSS-REFERENCE TO RELATED APPLICATION

This application is based upon and claims the benefit of priority of the prior Japanese Patent Application No. 2023-134294, filed on Aug. 21, 2023, the entire contents of which are incorporated herein by reference.

### FIELD

The embodiment discussed herein is related to a module terminal design program, a module terminal design method, and an information processing device.

### BACKGROUND

In recent years, in large scale integration (LSI) design, hierarchical design is often performed along with expansion of scale of a circuit. The hierarchical design is a method in which design is performed by dividing hierarchies in units of functions. In a case where the hierarchical design is performed, a module terminal that is an input/output (I/O) terminal for inter-hierarchy coupling is placed.

Japanese Laid-open Patent Publication No. 4-142060 is disclosed as related art.

### SUMMARY

According to an aspect of the embodiments, a non-transitory computer-readable recording medium stores a module terminal design program for causing a computer to execute processing including: creating, for each placement position included in a plurality of placement positions where a target macro that has a multilayer structure placed in a design target circuit is placeable according to a power supply structure of the design target circuit, a temporary macro that represents a placement pattern of terminals of each layer of the target macro; extracting, based on a result of comparison between placement patterns of the created temporary macros, a common pattern that represents a portion common among the temporary macros; extracting a difference pattern that represents a difference from the extracted common pattern among the created temporary macros for each placement position; registering the common pattern and the extracted difference pattern for each placement position in a library in association with the target macro; and creating, when the target macro is placed at any one placement position of the plurality of placement positions at a time of physical design of the design target circuit, a module terminal for a lifting target terminal in the target macro based on the common pattern and a difference pattern that corresponds to the any one placement position, with reference to the library.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a module terminal design method according to an embodiment;

FIG. 2 is an explanatory diagram illustrating an example of hierarchical design;

FIG. 3 is an explanatory diagram illustrating an example of logical inter-hierarchy coupling;

FIG. 4 is an explanatory diagram illustrating an example of physical inter-hierarchy coupling;

FIG. 5 is an explanatory diagram illustrating an example of a macro according to a placement position;

FIG. 6 is an explanatory diagram illustrating a system configuration example of a design support system 600;

FIG. 7 is a block diagram illustrating a hardware configuration example of a design support server 601;

FIG. 8 is a block diagram illustrating a functional configuration example of the design support server 601;

FIG. 9A is an explanatory diagram (part 1) illustrating a registration example of a macro library 620;

FIG. 9B is an explanatory diagram (part 2) illustrating the registration example of the macro library 620;

FIG. 10 is an explanatory diagram illustrating a format example of a module terminal generation library;

FIG. 11A is an explanatory diagram (part 1) illustrating a specific example of module terminal generation information;

FIG. 11B is an explanatory diagram (part 2) illustrating the specific example of the module terminal generation information;

FIG. 11C is an explanatory diagram (part 3) illustrating the specific example of the module terminal generation information;

FIG. 12A is an explanatory diagram (part 1) illustrating a creation example of a module terminal;

FIG. 12B is an explanatory diagram (part 2) illustrating the creation example of the module terminal;

FIG. 13 is a flowchart illustrating an example of a library creation processing procedure of the design support server 601;

FIG. 14A is a flowchart (part 1) illustrating an example of a specific processing procedure of macro common layer extraction processing;

FIG. 14B is a flowchart (part 2) illustrating the example of the specific processing procedure of the macro common layer extraction processing;

FIG. 15 is a flowchart illustrating an example of a specific processing procedure of difference library creation processing;

FIG. 16A is a flowchart (part 1) illustrating an example of a module terminal lifting processing procedure of the design support server 601;

FIG. 16B is a flowchart (part 2) illustrating the example of the module terminal lifting processing procedure of the design support server 601;

FIG. 17 is a flowchart illustrating an example of a specific processing procedure of module terminal creation processing;

FIG. 18 is a flowchart illustrating an example of a module terminal lifting processing procedure (interactive editor) of the design support server 601;

FIG. 19A is a flowchart (part 1) illustrating an example of a specific processing procedure of the macro common layer extraction processing according to a first example;

FIG. 19B is a flowchart (part 2) illustrating the example of the specific processing procedure of the macro common layer extraction processing according to the first example;

FIG. 20 is a flowchart illustrating an example of a specific processing procedure of the difference library creation processing according to the first example;

FIG. 21 is an explanatory diagram illustrating a specific example of a control file;

FIG. 22 is an explanatory diagram illustrating an example of a control file template;

FIG. 23 is a flowchart illustrating an example of a control file template creation processing procedure of the design support server 601;

FIG. 24A is an explanatory diagram (part 1) illustrating an example of an operation screen related to creation of the control file;

FIG. 24B is an explanatory diagram (part 2) illustrating the example of the operation screen related to the creation of the control file;

FIG. 25A is a flowchart (part 1) illustrating an example of the module terminal lifting processing procedure according to a second example;

FIG. 25B is a flowchart (part 2) illustrating the example of the module terminal lifting processing procedure according to the second example;

FIG. 26A is a flowchart (part 1) illustrating an example of the module terminal lifting processing procedure (interactive editor) according to the second example;

FIG. 26B is a flowchart (part 2) illustrating the example of the module terminal lifting processing procedure (interactive editor) according to the second example;

FIG. 27A is an explanatory diagram (part 1) illustrating an example of an operation screen related to input of the control file;

FIG. 27B is an explanatory diagram (part 2) illustrating the example of the operation screen related to the input of the control file;

FIG. 28A is a flowchart (part 1) illustrating an example of a module terminal check processing procedure according to a third example;

FIG. 28B is a flowchart (part 2) illustrating the example of the module terminal check processing procedure according to the third example;

FIG. 29 is a flowchart illustrating an example of a specific processing procedure of check processing;

FIG. 30A is a flowchart (part 1) illustrating an example of a specific processing procedure of use information acquisition processing;

FIG. 30B is a flowchart (part 2) illustrating the example of the specific processing procedure of the use information acquisition processing;

FIG. 31 is an explanatory diagram illustrating a specific example of a check result;

FIG. 32 is an explanatory diagram illustrating an example of an operation screen related to a module terminal check;

FIG. 33 is a flowchart illustrating an example of an error portion correction processing procedure according to the third example;

FIG. 34 is an explanatory diagram illustrating an example of an operation screen related to correction of an error portion; and

FIG. 35 is an explanatory diagram illustrating an example of an operation screen related to correction of an unplaced portion.

### DESCRIPTION OF EMBODIMENTS

As prior art, for example, there is a method of wiring in a semiconductor integrated circuit device having four or more wiring layers, with the lowest layer being a terminal layer, in which wiring is formed as upper wiring layers in the descending order of wiring length or wiring is formed as lower wiring layers in the ascending order of wiring length.

However, in the prior art, it is difficult to design a circuit including the module terminal for inter-hierarchy coupling when the hierarchical design of the LSI or the like is performed.

In one aspect, an object of an embodiment is to facilitate designing of a circuit including a module terminal.

Hereinafter, an embodiment of a module terminal design program, a module terminal design method, and an information processing device will be described in detail with reference to the drawings.

### Embodiment

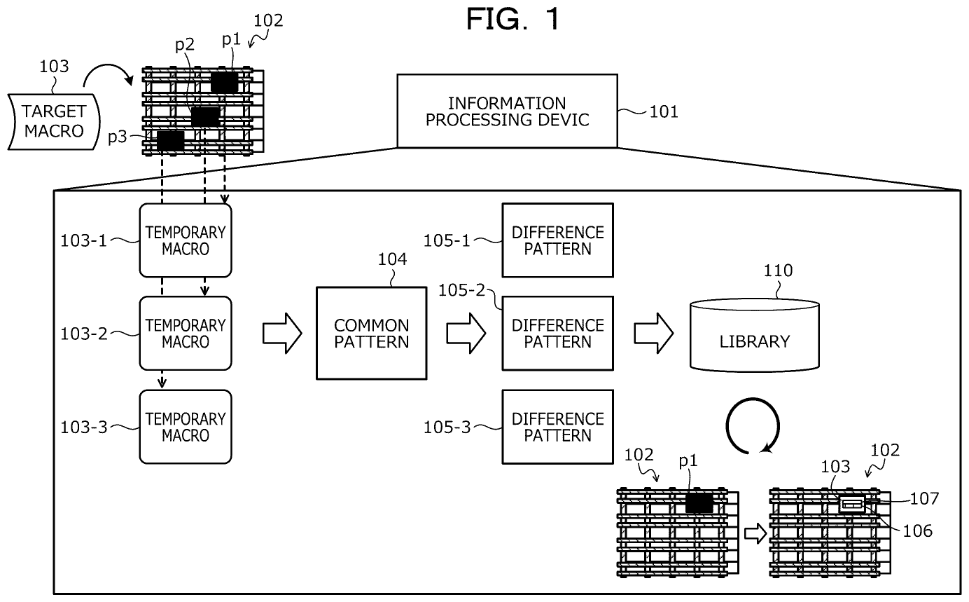

FIG. 1 is an explanatory diagram illustrating an example of a module terminal design method according to the embodiment. In FIG. 1, an information processing device 101 is a computer that supports design of a design target circuit. Here, the design target circuit is a circuit including a module terminal for inter-hierarchy coupling, and is, for example, an integrated circuit that implements one function of a hierarchically designed large scale integration (LSI).

In LSI design, in a case where non-hierarchical design is performed in which an entire chip is designed to be non-hierarchical (flat), there is a problem such as a turn around time (TAT) due to large scale. Thus, in the LSI design, hierarchical design is often performed in which design is performed by dividing hierarchies in units of functions.

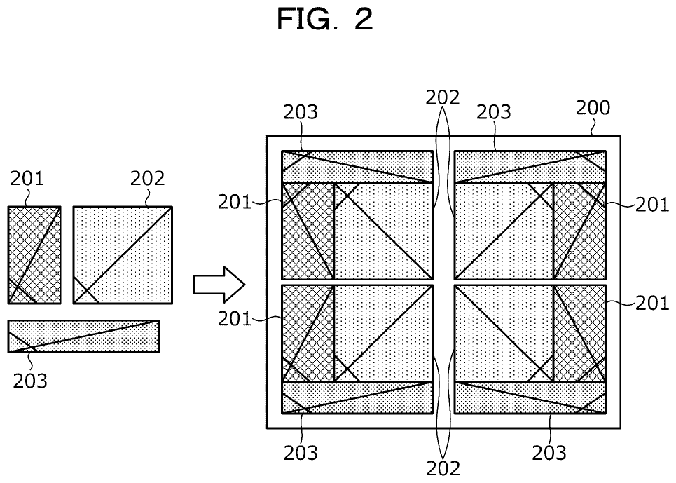

Here, the hierarchical design will be described with reference to FIG. 2.

FIG. 2 is an explanatory diagram illustrating an example of the hierarchical design. In FIG. 2, blocks 201 to 203 represent circuits of a lowest hierarchy. The lowest hierarchy is a hierarchy in which a Site region exists. The Site region is a region for placing a basic cell. Here, a case is assumed where hierarchical design including two hierarchies is performed.

A chip 200 represents a circuit of an uppermost hierarchy. The chip 200 is created by assembling the blocks 201 to 203. At this time, portions having the same function in the chip 200 may be designed using the same block. In this manner, in the hierarchical design, design efficiency may be enhanced by performing the design in units of functions or repeatedly using the block of the same function.

In a case where the hierarchical design is performed, a module terminal for coupling between hierarchies is placed. The module terminal is an input/output (I/O) terminal for inter-hierarchy coupling.

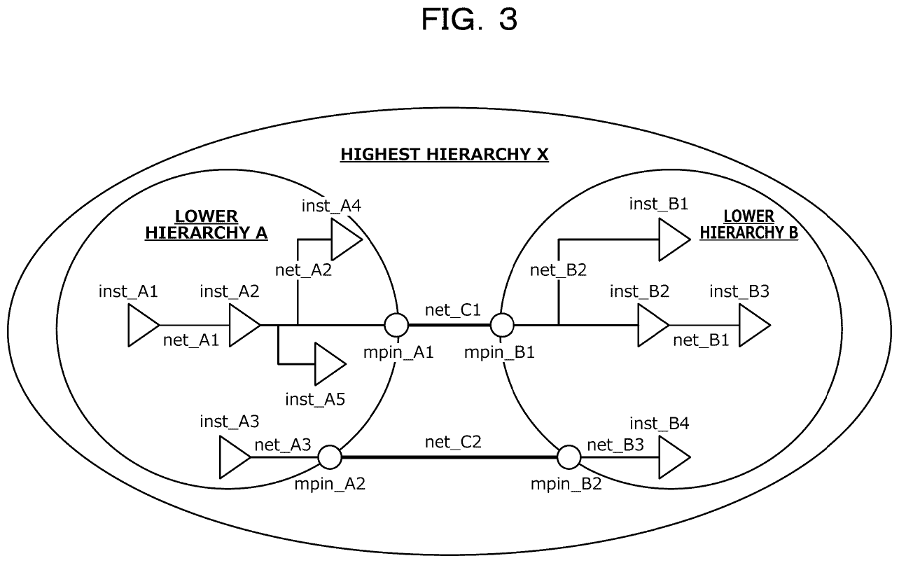

Here, an example of inter-hierarchy coupling via the module terminal (logical image) will be described with reference to FIG. 3.

FIG. 3 is an explanatory diagram illustrating an example of logical inter-hierarchy coupling. In FIG. 3, an uppermost hierarchy X includes a lower hierarchy A and a lower hierarchy B. Module terminals that couple the lower hierarchies A and B are represented by mpin_A1, mpin_A2, mpin_B1, and mpin_B2.

Nets in the case of being viewed from the hierarchies on a lower side (lower hierarchies A and B) are represented by net_A1, net_A2, net_A3, net_B1, net_B2, and net_B3. The net_A1 and the net_B1 represent nets in the hierarchies. The net_A2, the net_A3, the net_B2, and the net_B3 represent nets coupled to the outside of the hierarchies.

Inter-hierarchy nets in the case of being viewed from the hierarchy on a higher side (uppermost hierarchy X) are represented by net_C1 and net_C2. Instances corresponding to macros (or cells) are represented by inst_A1 to inst_A5 in the lower hierarchy A and inst_B1 to inst_B4 in the lower hierarchy B.

Each of the uppermost hierarchy X, the lower hierarchies A and B, and the respective macros is individually designed. For example, each macro is designed by a macro designer. Furthermore, the lower hierarchies A and B are designed by lower hierarchy designers different from each other. Furthermore, the uppermost hierarchy X is designed by an uppermost hierarchy designer. A detailed internal structure of each macro is not visible to the lower hierarchy designers. Furthermore, a detailed internal structure of each of the lower hierarchies A and B is not visible to the uppermost hierarchy designer.

Here, the module terminals are physically divided into two types, a Frame module terminal placed at a Frame and a lifting module terminal placed at a terminal of a cell, depending on a difference in placement position. The Frame module terminal is placed at a Frame side of the own hierarchy in order to implement wiring in the own hierarchy.

The placement position of the Frame module terminal is, for example, adjusted between related hierarchies and determined. A wiring layer of the Frame module terminal is selected from, for example, used wiring layers of the nets in the hierarchies after adjustment with a related hierarchy. The Frame module terminal is coupled to, for example, a common net such as a data signal.

Furthermore, the Frame module terminals includes an abutment type and a non-abutment type. In the abutment type, coupling is performed by abutting when hierarchies are assembled. In the non-abutment type, coupling is performed by wiring in an upper hierarchy when hierarchies are assembled.

The lifting module terminal is placed at a terminal of a cell in the lower hierarchy in order to implement wiring in the upper hierarchy. A placement position of the lifting module terminal is determined according to a placement position of the cell. The wiring is implemented in view of the whole on a side of the upper hierarchy (wiring is not performed in the lower hierarchy).

As a wiring layer of the lifting module terminal, an upper wiring layer is used so as not to affect net wiring in the lower hierarchy. Therefore, a module terminal layer is also an upper wiring layer. The lifting module terminal is coupled to, for example, a net for which a fine wiring pattern is desired to be performed, such as a clock net.

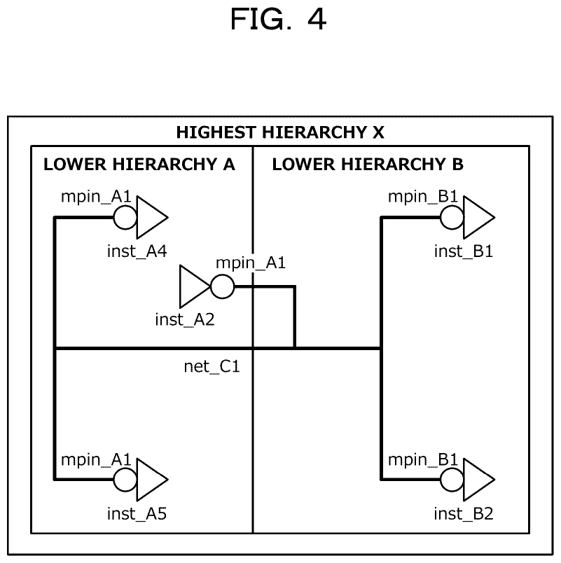

Here, an example of inter-hierarchy coupling via the module terminal (physical image) will be described with reference to FIG. 4.

FIG. 4 is an explanatory diagram illustrating an example of physical inter-hierarchy coupling. In FIG. 4, the uppermost hierarchy X including the lower hierarchy A and the lower hierarchy B is illustrated. The mpin_A1 and the mpin_B1 are the lifting module terminals placed at terminals of the respective macros (cells) (the inst_A2, the inst_A4, the inst_A5, the inst_B1, and the inst_B2).

Wiring of the lifting module terminals is implemented in the uppermost hierarchy (net_C1) in view of the module terminals of the entire nets. In this manner, according to the lifting module terminals, by lifting the module terminals, the wiring may be performed in view of coupling information of the entire nets.

For example, the wiring may be implemented in view of the entire nets on the side of the upper hierarchy on a net for which a wiring pattern is desired to be performed in consideration of the entire nets, such as the clock net. On the other hand, in the case of the Frame module terminals, since wiring is implemented in the lower hierarchies, the wiring may not be implemented in view of the entire nets.

Therefore, in a case where it is desired to perform a wiring pattern in consideration of the entire nets such as the clock net, the lifting module terminals are used. Examples of a method of lifting the lifting module terminal of a prior technology include patterns 1 and 2.

The pattern 1 is the lifting method in the case of a cell with terminal restriction. In the pattern 1, the module terminal has the same layer, the same shape, and the same placement position as those of a cell (macro) terminal. Furthermore, from a bulk layer to a module terminal layer and the placement position of a cell (macro) are created by the macro designer.

For example, in a case where the module terminal is generated for an output pin (x) of an M (Metal) 8 layer, the module terminal has the same layer (M8 layer), the same shape, and the same placement position as the output pin (x). In the pattern 1, the module terminal is automatically placed at the time of, for example, instance placement within a batch version program or an interactive editor.

The pattern 2 is the lifting method in the case of a cell without terminal restriction. In the pattern 2, the module terminal has a different layer, a different shape, and a different placement position from those of a cell (macro) terminal, and has the layer and the shape that match those of a usable layer at the time of wiring. A module terminal layer, the placement position, and coupling from the cell terminal to the module terminal may be created for convenience of a side of layout.

For example, in a case where the module terminal is generated for an output pin (x) of an M2 layer, the module terminal has the different layer (for example, M8 layer), the different shape, and the different placement position from those of the output pin (x). In the pattern 2, for example, placement of the module terminal is manually implemented in an interactive editor, and coupling with a cell (macro) terminal layer is also manually wired.

Miniaturization of a semiconductor technology in recent years causes, regarding the LSI design, an increase in an area of power supply wiring, complication of mask design rules, and a situation where electrical restriction become strict. Since the module terminal is also affected by the miniaturization of the semiconductor technology, various problems occur.

For example, since a power supply structure is complicated and dense, when the cell terminal layer is created in the upper wiring layer, a placement position is greatly limited. In a case where a terminal layer of the module terminal is created in the upper layer, placement restriction occurs due to power supply interference, and a degree of freedom in placement is reduced. The higher the layer of a terminal definition, the greater a degree of the power supply interference and the lower the degree of freedom in placement.

Here, in the case of the pattern 1 (with terminal restriction) without changing the terminal layer of the module terminal, it is conceivable to prepare a plurality of macros in consideration of a difference in terminal structure depending on placement positions in order to improve the degree of freedom. In this case, it is needed to determine cell placement at a stage of logic design. However, since a cell placement position is unknown at the stage of the logic design, the logic design may not be performed even when the plurality of macros is prepared.

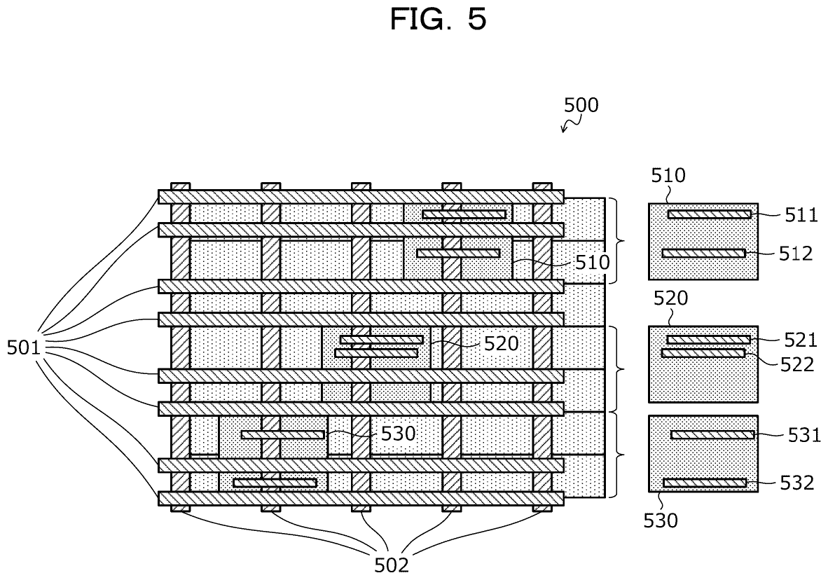

Here, a macro according to a placement position will be described with reference to FIG. 5.

FIG. 5 is an explanatory diagram illustrating an example of the macro according to the placement position. In FIG. 5, an M8 power supply (power supply wiring) 501 and an M7 power supply (power supply wiring) 502 in a circuit 500 are illustrated. The circuit 500 corresponds to, for example, the lower hierarchy A or the lower hierarchy B illustrated in FIGS. 3 and 4.

Here, in a case where a macro including a terminal (I/O terminal) of the M8 layer is placed in the circuit 500, as described above, it is conceivable to prepare a plurality of macros having different terminal structures depending on placement positions. Here, it is assumed that three types of macros 510, 520, and 530 are prepared.

Terminals 511 and 512 in the macro 510 are the terminals of the M8 layer. Terminals 521 and 522 in the macro 520 are the terminals of the M8 layer. Terminals 531 and 532 in the macro 530 are the terminals of the M8 layer. Note that, in FIG. 5, only the terminals of the M8 layer among the terminals in the respective macros 510, 520, and 530 are illustrated.

However, cell placement positions are unknown at a stage of logic design of the circuit 500. Thus, even when the three types of macros 510, 520, and 530 are prepared in consideration of the difference in terminal structure depending on the placement positions, it is not possible to perform the logic design (logical entry may not be performed).

Furthermore, in a case where the terminal layer of the module terminal is lowered in the pattern 2 (without terminal restriction), coupling between the module terminal layer and a macro terminal layer is created for convenience of the side of the layout. However, since the terminal restriction is strict, restriction is generated on the module terminal layer, the position, and coupling of the macro terminal layer.

Thus, when a pattern up to the module terminal is freely designed on the side of the layout, the restriction may not be kept and an error occurs. The restriction is, for example, restriction for electromigration and antenna error suppression (terminal layer, terminal position, wiring length, wiring detouring condition), or the like.

Therefore, in the present embodiment, a module terminal design method will be described which facilitates designing of a circuit including a module terminal for inter-hierarchy coupling in consideration of restriction conditions (placement restriction and the like) even in a circuit having a complicated power supply structure. Here, processing examples (corresponding to processing of (1) to (5) below) of the information processing device 101 will be described.

(1) The information processing device 101 creates a temporary macro for each placement position included in a plurality of placement positions where a target macro 103 having a multilayer structure placed in a design target circuit 102 may be placed according to a power supply structure of the design target circuit 102. Here, the design target circuit 102 is a circuit to be subjected to hierarchical design, and corresponds to, for example, the lower hierarchy A or the lower hierarchy B illustrated in FIGS. 3 and 4.

The target macro 103 is a circuit in which multilayer wiring may be provided and is a macro to be lifted. The macro to be lifted is a macro that generates a “lifting module terminal” that is a terminal for inter-hierarchy coupling. The target macro 103 is, for example, a macro coupled to the clock net.

For example, the target macro 103 has a terminal placed in an upper layer, and coupled to the outside by wiring via a module terminal (lifting module terminal) generated at the terminal. Note that the macro is a circuit including one or more cells. The cell is, for example, a logic gate such as a NOT gate or an AND gate, or a circuit block obtained by combining these. In the following description, the macro and the cell may be described as being synonymous.

The placement position is a position of placement at the time of physical design of the design target circuit 102. There is the plurality of placement positions where the target macro 103 may be placed according to the power supply structure of the design target circuit 102. The power supply structure of the design target circuit 102 is represented by, for example, a state of power supply wiring of each layer of the design target circuit 102. Furthermore, the target macro 103 has a different preferable terminal structure depending on the placement position.

Thus, for example, the information processing device 101 creates the temporary macro for each placement position where placement is possible in the design target circuit 102 based on a net list of the target macro 103. The temporary macro represents a placement pattern of terminals (I/O terminals) of each layer in the target macro 103. The placement pattern may include, for example, placement of a via coupling between different layers. The net list is information representing a coupling relationship between the terminals in the target macro 103.

Here, a case is assumed where temporary macros 103-1, 103-2, and 103-3 are created for the target macro 103. The temporary macro 103-1 corresponds to a placement position p1 in the design target circuit 102. The temporary macro 103-2 corresponds to a placement position p2 in the design target circuit 102. The temporary macro 103-3 corresponds to a placement position p3 in the design target circuit 102.

The respective temporary macros 103-1, 103-2, and 103-3 are macros that implement functions of the target macro 103, and have different terminal structures from each other. Note that the temporary macros 103-1, 103-2, and 103-3 are created such that, for example, the number of common portions from a lowest layer is as large as possible.

(2) The information processing device 101 extracts a common pattern 104 based on a result of comparison of placement patterns among the created temporary macros 103-1, 103-2, and 103-3. Here, the common pattern 104 represents a portion where placement of terminals is common among the temporary macros 103-1, 103-2, and 103-3.

For example, it is assumed that the temporary macros 103-1, 103-2, and 103-3 represent the placement patterns of the terminals of the respective layers from a bulk layer to an M5 layer. Furthermore, it is assumed that placement of the terminals of the respective layers from the bulk layer to an M2 layer is common among the temporary macros 103-1, 103-2, and 103-3. In this case, the information processing device 101 extracts, as the common pattern 104, the placement pattern of the terminals of the respective layers from the lowest layer (bulk layer) to the common uppermost layer (M2 layer).

(3) The information processing device 101 extracts, for each placement position, a difference pattern representing a difference from the extracted common pattern 104 among the created temporary macros 103-1, 103-2, and 103-3. Here, a case is assumed where a difference pattern 105-1 is extracted for the temporary macro 103-1.

Furthermore, a case is assumed where a difference pattern 105-2 is extracted for the temporary macro 103-2. Furthermore, a case is assumed where a difference pattern 105-3 is extracted for the temporary macro 103-3. The respective difference patterns 105-1, 105-2, and 105-3 represent a placement patterns of the terminals of the respective layers from an M3 layer to the M5 layer.

(4) The information processing device 101 registers the extracted common pattern 104 and the extracted difference patterns 105-1, 105-2, and 105-3 for the respective placement positions p1 to p3 in a library 110 in association with the target macro 103. For example, the information processing device 101 registers the common pattern 104 as the placement pattern (terminal structure) of the target macro 103, and componentizes and registers the difference patterns 105-1, 105-2, and 105-3 according to the placement positions p1 to p3.

The processing of (1) to (4) described above is executed as, for example, preliminary preparation before the physical design of the design target circuit 102.

(5) At the time of the physical design of the design target circuit 102, the information processing device 101 creates a module terminal for a lifting target terminal in the target macro 103 when the target macro 103 is placed at any one placement position of the plurality of placement positions (placement positions p1 to p3) where the target macro may be placed, with reference to the library 110.

Here, the lifting target terminal is a terminal at which the module terminal (lifting module terminal) is placed. The lifting target terminal is, for example, a terminal of the uppermost layer from which wiring coupled to the outside is drawn out among the terminals in the target macro 103. The lifting target terminal may be specified by, for example, a macro designer.

Here, a case is assumed where the target macro 103 is placed at the placement position p1 among the placement positions p1 to p3 where the target macro 103 may be placed. In this case, the information processing device 101 creates, with reference to the library 110, the module terminal for the lifting target terminal in the target macro 103 based on the common pattern 104 corresponding to the target macro 103 and the difference pattern 105-1 corresponding to the placement position p1.

For example, the information processing device 101 places the terminals and vias of the respective layers in the target macro 103 based on the common pattern 104 and the difference pattern 105-1 (concept of restoring the temporary macro 103-1). Then, the information processing device 101 creates a module terminal having the same shape as that of the lifting target terminal in the uppermost layer of the target macro 103, and places the created module terminal at the lifting target terminal (with the same layer, the same shape, and the same placement position).

Here, the lifting target terminal in the target macro 103 is referred to as a “terminal 106”. In this case, a module terminal 107 is created for the terminal 106. The module terminal 107 is a module terminal (lifting module terminal) with the same layer, the same shape, and the same placement position as those of the terminal 106.

In this manner, according to the information processing device 101, a portion (common pattern 104) common among the temporary macros 103-1, 103-2, and 103-3 for the respective placement positions p1 to p3 where placement is possible according to the power supply structure of the design target circuit 102 may be formed into a library as a formal macro. Furthermore, according to the information processing device 101, the difference patterns 105-1, 105-2, and 105-3 between the temporary macros 103-1, 103-2, and 103-3 for the respective placement positions p1 to p3 and the common pattern 104 may be componentized and registered. As a result, the information processing device 101 may provide the portion not affected by the placement positions p1 to p3 in the target macro 103 as the formal macro, and may provide a non-common portion as a component.

Furthermore, according to the information processing device 101, at the time of the physical design of the design target circuit 102, it is possible to enable creation of the placement pattern of the terminals on the side of the layout from the common pattern 104 registered as the formal macro and the difference pattern (for example, the difference pattern 105-1) according to the actual placement position (for example, the placement position p1). As a result, a design support server 601 may appropriately generate a module terminal in consideration of placement restriction and the like even in a circuit having a complicated power supply structure, and may facilitate designing of a circuit including a module terminal.

### (System Configuration Example of Design Support System 600)

Next, a system configuration example of a design support system 600 including the information processing device 101 illustrated in FIG. 1 will be described. Here, a case will be described where the information processing device 101 illustrated in FIG. 1 is applied to the design support server 601 in the design support system 600 as an example.

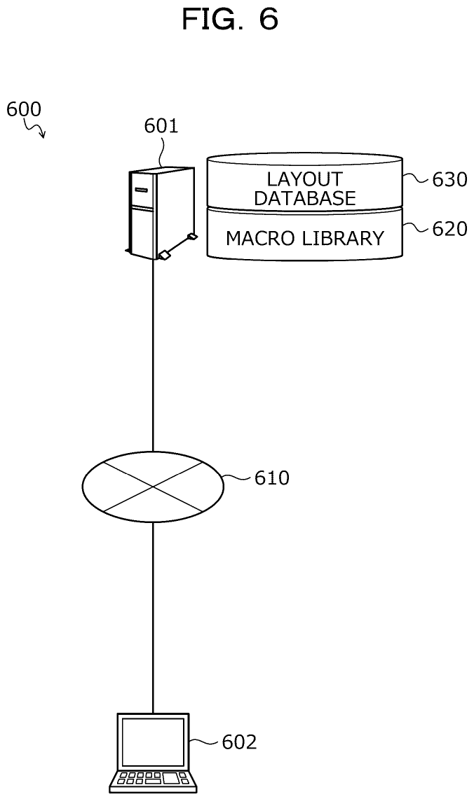

FIG. 6 is an explanatory diagram illustrating the system configuration example of the design support system 600. In FIG. 6, the design support system 600 includes the design support server 601 and a client terminal 602. In the design support system 600, the design support server 601 and the client terminal 602 are coupled via a wired or wireless network 610. The network 610 is, for example, the Internet, a local area network (LAN), a wide area network (WAN), or the like.

Here, the design support server 601 includes a macro library 620 and a layout database 630, and supports design of a design target circuit. The design target circuit is, for example, an integrated circuit that implements one function of the hierarchically designed LSI, and includes an I/O terminal (module terminal) for inter-hierarchy coupling.

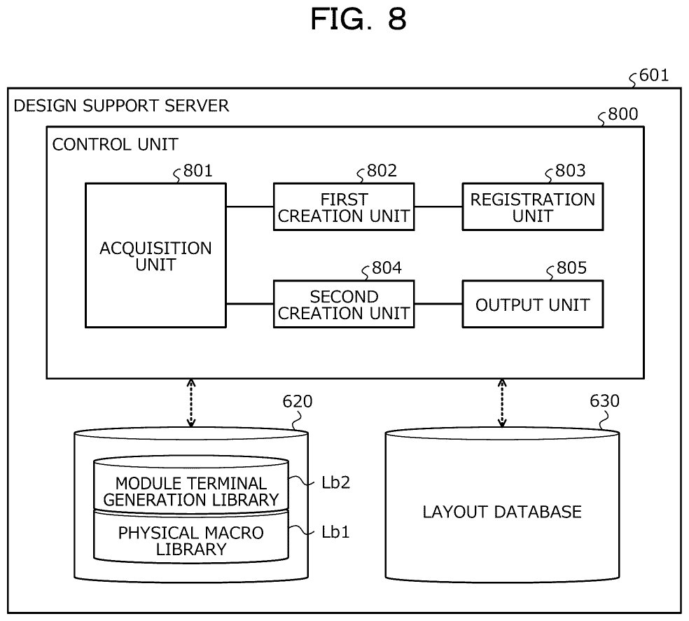

The macro library 620 stores information related to a macro (cell). The macro library 620 includes, for example, a physical macro library Lb1 and a module terminal generation library Lb2 illustrated in FIG. 8 to be described later. The layout database 630 stores information for performing layout of the design target circuit.

The client terminal 602 is a computer used by a user of the design support system 600. The user is, for example, a designer of the design target circuit, a designer of a macro placed in the design target circuit, or the like. The client terminal 602 is, for example, a personal computer (PC), a tablet PC, or the like.

Note that, here, the design support server 601 and the client terminal 602 are separately provided. However, the present embodiment is not limited to this. For example, the design support server 601 may be implemented by the client terminal 602. Furthermore, the design support system 600 may include a plurality of the client terminals 602.

### (Hardware Configuration Example of Design Support Server 601)

Next, a hardware configuration example of the design support server 601 will be described.

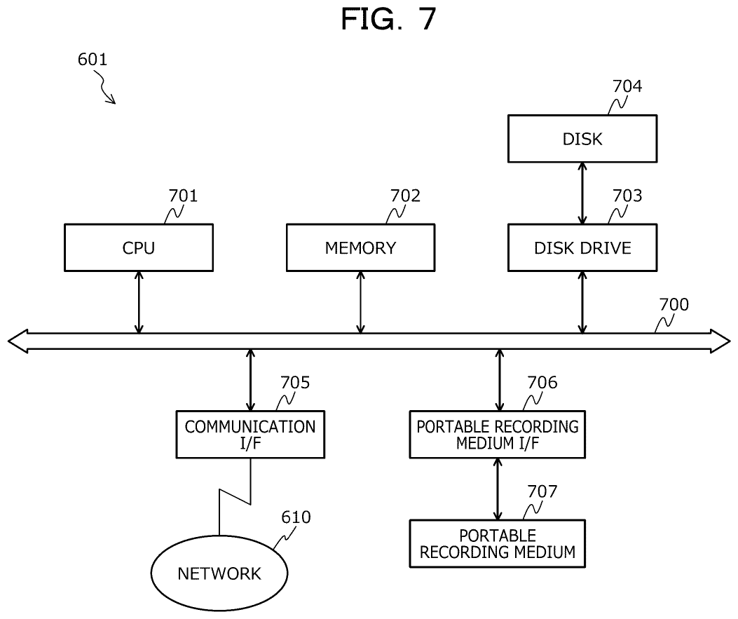

FIG. 7 is a block diagram illustrating the hardware configuration example of the design support server 601. In FIG. 7, the design support server 601 includes a central processing unit (CPU) 701, a memory 702, a disk drive 703, a disk 704, a communication interface (I/F) 705, a portable recording medium I/F 706, and a portable recording medium 707. Furthermore, the respective components are coupled to each other by a bus 700.

Here, the CPU 701 is in charge of overall control of the design support server 601. The CPU 701 may include a plurality of cores. The memory 702 includes, for example, a read only memory (ROM), a random access memory (RAM), a flash ROM, and the like. For example, the flash ROM stores an operating system (OS) program, the ROM stores application programs, and the RAM is used as a work area for the CPU 701. The programs stored in the memory 702 are loaded into the CPU 701, to cause the CPU 701 to execute coded processing.

The disk drive 703 controls reading/writing of data from/into the disk 704, under the control of the CPU 701. The disk 704 stores data that is written under the control of the disk drive 703. Examples of the disk 704 include a magnetic disk, an optical disk, and the like.

The communication I/F 705 is coupled to the network 610 through a communication line, and is coupled to an external computer (for example, the client terminal 602 illustrated in FIG. 2) via the network 610. Additionally, the communication I/F 705 manages an interface between the network 610 and the inside of the device, and controls input and output of data from the external computer. Examples of the communication I/F 705 include a modem, a LAN adapter, and the like.

The portable recording medium I/F 706 controls reading/writing of data from/into the portable recording medium 707, under the control of the CPU 701. The portable recording medium 707 stores data that is written under the control of the portable recording medium I/F 706. Examples of the portable recording medium 707 include a compact disc (CD)-ROM, a digital versatile disk (DVD), a universal serial bus (USB) memory, and the like.

Note that the design support server 601 may include, for example, an input device, a display, and the like in addition to the components described above. Furthermore, the design support server 601 does not have to include, for example, the portable recording medium I/F 706 and the portable recording medium 707 among the components described above. Furthermore, the client terminal 602 illustrated in FIG. 6 may also be implemented by a hardware configuration similar to that of the design support server 601. Note that the client terminal 602 includes, for example, an input device, a display, and the like, in addition to the components described above.

### (Functional Configuration Example of Design Support Server 601)

Next, a functional configuration example of the design support server 601 will be described.

FIG. 8 is a block diagram illustrating the functional configuration example of the design support server 601. In FIG. 8, the design support server 601 includes an acquisition unit 801, a first creation unit 802, a registration unit 803, a second creation unit 804, and an output unit 805. The acquisition unit 801 to the output unit 805 have functions serving as a control unit 800, and for example, those functions are implemented by causing the CPU 701 to execute a program stored in a storage device such as the memory 702, the disk 704, or the portable recording medium 707 illustrated in FIG. 7 or by the communication I/F 705. A processing result of each functional unit is stored in, for example, a storage device such as the memory 702 or the disk 704.

The acquisition unit 801 acquires a net list related to a target macro. Here, the target macro is a macro to be lifted among macros placed in a design target circuit. The design target circuit is, for example, an integrated circuit that implements one function of hierarchically designed LSI, and includes a module terminal.

The target macro is, for example, a macro coupled to the clock net. The clock net is needed to reduce delay and skew as compared with the common net such as the data signal. The net list is information representing a coupling relationship between terminals in the target macro.

For example, the acquisition unit 801 acquires the net list related to the target macro by generating the net list from circuit information such as hardware description language (HDL) description and a circuit diagram of the target macro.

The circuit information (the HDL description, the circuit diagram, and the like) of the target macro is acquired from, for example, the client terminal 602 (see FIG. 6) of a macro designer. Furthermore, the acquisition unit 801 may acquire the net list related to the target macro from the client terminal 602 of the macro designer.

The first creation unit 802 creates a temporary macro for each placement position included in a plurality of placement positions where the target macro may be placed according to a power supply structure of the design target circuit. Here, the temporary macro is information representing a placement pattern of the terminals of each layer in the target macro having a multilayer structure.

The placement pattern includes, for example, placement of a via coupling between different layers. The plurality of placement positions is determined so as to satisfy requested placement restriction according to, for example, a state of power supply wiring of the design target circuit. The plurality of placement positions may be manually determined by, for example, the macro designer or the like.

For example, the first creation unit 802 selects any one placement position (assumed placement position) from the plurality of placement positions where placement is possible. Then, the first creation unit 802 determines, on the assumption that placement is performed at the selected placement position in the design target circuit, wiring layers and placement positions of terminals (temporary I/O terminals) in the temporary macro according to the placement position.

The wiring layer corresponds to a wiring layer of the target macro, and is common to all the terminals in the temporary macro. The wiring layer is a layer (wiring layer for external coupling) to which wiring with the outside is coupled, and is, for example, an uppermost layer of the target macro. The wiring layer is specified by, for example, the macro designer. The placement positions of the terminals in which layer in the temporary macro are determined in consideration of, for example, the wiring layer and terminal restriction of the target macro.

The terminal restriction is, for example, restriction for electromigration and antenna error suppression (terminal layer, terminal position, wiring length, wiring detouring condition, or the like). The restriction to be considered may be selected by, for example, specifying a use of the target macro.

Then, the first creation unit 802 performs net wiring coupling in the temporary macro. In the net wiring coupling, for example, coupling between the terminals from a drain to a metal layer in the temporary macro is performed. Next, the first creation unit 802 performs a timing check of the temporary macro. Then, the first creation unit 802 performs a design rule check of the temporary macro.

As a result, the temporary macro corresponding to the selected placement position (assumed placement position) is created. The temporary macro is created for each of the plurality of placement positions where placement is possible. At this time, the first creation unit 802 creates each temporary macro such that, for example, the number of common portions from a lowest layer among the temporary macros is as large as possible.

Note that, in the case of a timing error or design rule violation, for example, description or a restriction condition of the target macro is changed, and the temporary macro is created again.

The registration unit 803 extracts, based on a result of comparison of the placement patterns among the created temporary macros, a common pattern representing a portion common between the temporary macros. For example, the registration unit 803 extracts, as the common pattern, the placement pattern of the terminals of the respective layers from the lowest layer (bulk layer) to the common uppermost layer.

Next, the registration unit 803 extracts, for each placement position, a difference pattern representing a difference from the extracted common pattern among the created temporary macros. For example, the registration unit 803 extracts, for each temporary macro, a remaining portion (from an immediately upper layer of the common pattern to the uppermost layer) excluding the common pattern as the difference pattern.

Then, the registration unit 803 registers the extracted common pattern and the extracted difference patterns for the respective placement positions in the macro library 620 in association with the target macro. For example, the registration unit 803 performs a timing check of the extracted common pattern. Furthermore, the registration unit 803 performs a design rule check of the common pattern.

Note that, in the case of a timing error or design rule violation, for example, the description or the restriction condition of the target macro is changed, and the common pattern is extracted again.

Then, the registration unit 803 registers the extracted common pattern as a formal macro in the physical macro library Lb1 in the macro library 620 in association with the target macro (for example, a macro name). Furthermore, the registration unit 803 registers the placement position and the difference pattern in the module terminal generation library Lb2 in the macro library 620 in association with the target macro (for example, the macro name).

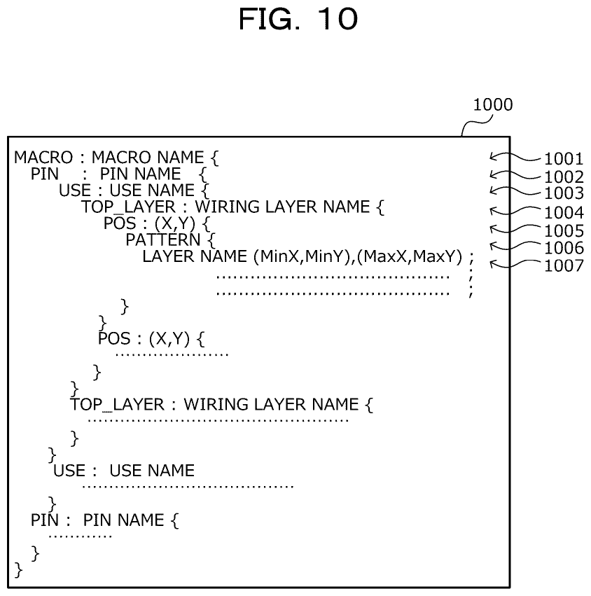

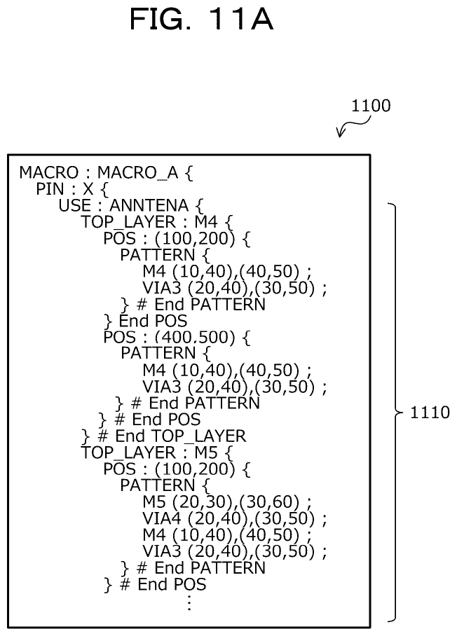

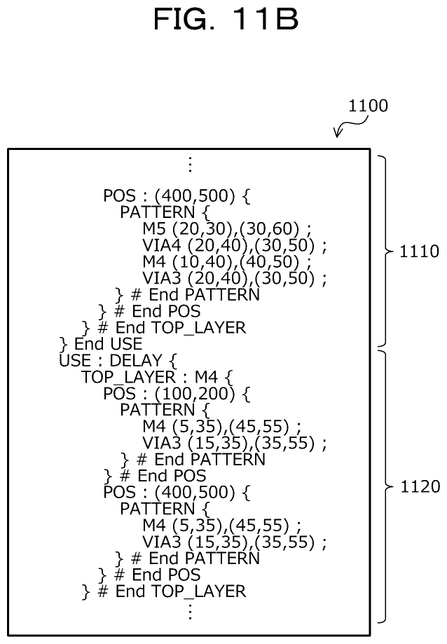

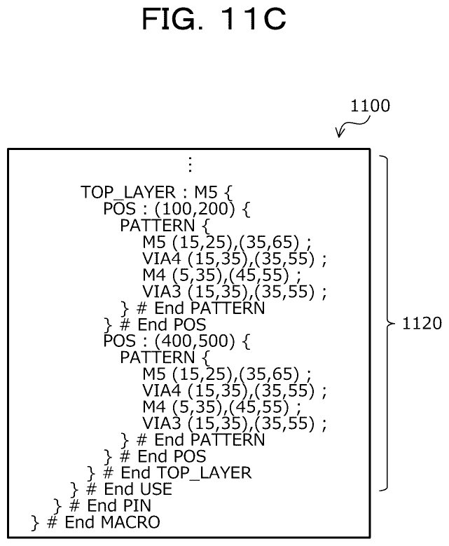

Note that content stored in the module terminal generation library Lb2 will be described later with reference to FIGS. 10, 11A, 11B, and 11C.

The acquisition unit 801 acquires information for performing layout of the design target circuit. Here, the information for performing the layout includes, for example, a logic design result of the design target circuit. The information for performing the layout includes, for example, placement information and net information of each macro in the design target circuit.

The net information represents net wiring that couples between the macros. The net wiring includes, for example, an inter-hierarchy net that couples the design target circuit and an external circuit. The information for performing the layout of the design target circuit is acquired from, for example, the client terminal 602 of a designer of the design target circuit.

The acquired information for performing the layout of the design target circuit is stored in, for example, the layout database 630 illustrated in FIG. 6.

The second creation unit 804 creates a module terminal for a lifting target terminal in the target macro when the target macro is placed at a first placement position of the plurality of placement positions where the target macro may be placed, at the time of physical design of the design target circuit, with reference to the macro library 620. The physical design is to physically determine placement wiring of cells in the design target circuit.

The physical design of the design target circuit is performed based on, for example, the layout database 630. The lifting target terminal is a terminal at which the module terminal (lifting module terminal) is placed. The lifting target terminal is, for example, a terminal of the wiring layer (uppermost layer) among the terminals in the target macro. The lifting target terminal is specified by, for example, the macro designer.

For example, the second creation unit 804 specifies the common pattern corresponding to the target macro with reference to the physical macro library Lb1. Furthermore, the second creation unit 804 specifies a difference pattern corresponding to the first placement position for the target macro with reference to the module terminal generation library Lb2.

Then, the second creation unit 804 creates the module terminal for the lifting target terminal in the target macro based on the specified common pattern and the specified difference pattern corresponding to the first placement position. Regarding the module terminal, for example, the second creation unit 804 places the terminals and the vias of the respective layers in the target macro based on the common pattern and the difference pattern.

Then, the second creation unit 804 creates the module terminal for the lifting target terminal in the uppermost layer of the target macro, and places the created module terminal at the lifting target terminal. The module terminal is the lifting module terminal with the same layer, the same shape, and the same placement position as those of the lifting target terminal.

The output unit 805 outputs information related to the created module terminal. The information related to the module terminal is, for example, layout data in which the module terminal (lifting module terminal) is placed at the lifting target terminal in the target macro placed in the design target circuit.

Examples of an output format of the output unit 805 include storage in a storage device such as the memory 702 or the disk 704 (for example, the layout database 630), transmission to another computer (for example, the client terminal 602) by the communication I/F 705, display on a display (not illustrated), print output to a printer (not illustrated), and the like.

Furthermore, for the target macro, the first creation unit 802 may create the temporary macro for each combination of each use of a plurality of uses applicable to the target macro and each placement position of the plurality of placement positions where placement is possible according to the power supply structure of the design target circuit. Here, the use represents what the target macro is used to optimize.

Examples of the use include antenna error suppression, electromigration suppression, delay suppression, and the like. A terminal structure in the target macro is determined according to, for example, the use. Therefore, the first creation unit 802 may create the temporary macro in consideration of not only the placement position of the target macro but also the use of the target macro (restriction condition according to the use).

Furthermore, the registration unit 803 may extract, based on a result of comparison of the placement patterns among the temporary macros created for each combination of the use and the placement position, the common pattern representing the portion common between the temporary macros. In this case, the registration unit 803 extracts the difference pattern representing the difference from the extracted common pattern among the created temporary macros for each combination of the use and the placement position. Then, the registration unit 803 registers the extracted common pattern and the extracted difference patterns for each combination in the macro library 620 in association with the target macro.

In this case, the second creation unit 804 may create the module terminal for the lifting target terminal in the target macro based on the common pattern and a difference pattern corresponding to a combination of a first use and the first placement position when the target macro is placed at the first placement position for the first use, at the time of the physical design of the design target circuit, with reference to the macro library 620.

Here, the first use is any one use of the plurality of uses applicable to the target macro. The first placement position is any one placement position of the plurality of placement positions where the target macro may be placed. For example, the second creation unit 804 specifies the common pattern corresponding to the target macro with reference to the physical macro library Lb1.

Furthermore, the second creation unit 804 specifies the difference pattern corresponding to the combination of the first use and the first placement position for the target macro with reference to the module terminal generation library Lb2. Then, the second creation unit 804 creates the module terminal for the lifting target terminal in the target macro based on the specified common pattern and the specified difference pattern.

Furthermore, for the target macro, the first creation unit 802 may create the temporary macro for each combination of each wiring layer of a plurality of wiring layers for external coupling applicable to the target macro and each placement position of the plurality of placement positions where placement is possible according to the power supply structure of the design target circuit. Here, the wiring layer for external coupling is a layer to which wiring coupled to the outside is coupled, and is, for example, the uppermost layer of the target macro.

As the wiring layer of the target macro, for example, an upper layer such as the M8 layer is used. The terminal structure in the target macro changes according to, for example, the wiring layer of the target macro. Therefore, the first creation unit 802 may create the temporary macro for each placement position where the target macro may be placed according to the wiring layer of the target macro.

Furthermore, the registration unit 803 may extract, based on a result of comparison of the placement patterns among the temporary macros created for each combination of the wiring layer and the placement position, the common pattern representing the portion common between the temporary macros. In this case, the registration unit 803 extracts the difference pattern representing the difference from the extracted common pattern among the created temporary macros for each combination of the wiring layer and the placement position. Then, the registration unit 803 registers the extracted common pattern and the extracted difference patterns for each combination in the macro library 620 in association with the target macro.

In this case, the second creation unit 804 may create the module terminal for the lifting target terminal in the target macro based on the common pattern and a difference pattern corresponding to a combination of a first wiring layer and the first placement position when the target macro is placed at the first placement position corresponding to the first wiring layer, at the time of the physical design of the design target circuit, with reference to the macro library 620.

Here, the first wiring layer is any one wiring layer of the plurality of wiring layers applicable to the target macro. The first placement position is any one placement position of the plurality of placement positions where the target macro may be placed, corresponding to the first wiring layer. For example, the second creation unit 804 specifies the common pattern corresponding to the target macro with reference to the physical macro library Lb1.

Furthermore, the second creation unit 804 specifies the difference pattern corresponding to the combination of the first wiring layer and the first placement position for the target macro with reference to the module terminal generation library Lb2. Then, the second creation unit 804 creates the module terminal for the lifting target terminal in the target macro based on the specified common pattern and the specified difference pattern.

Note that, in the above description, the temporary macro for each placement position where placement is possible according to the power supply structure of the design target circuit is created in the design support server 601. However, the present embodiment is not limited to this. For example, in the client terminal 602, a temporary macro for each placement position where placement is possible by the macro designer may be created. In this case, the design support server 601 may acquire the temporary macro created in the client terminal 602.

### (Registration Example of Macro Library 620)

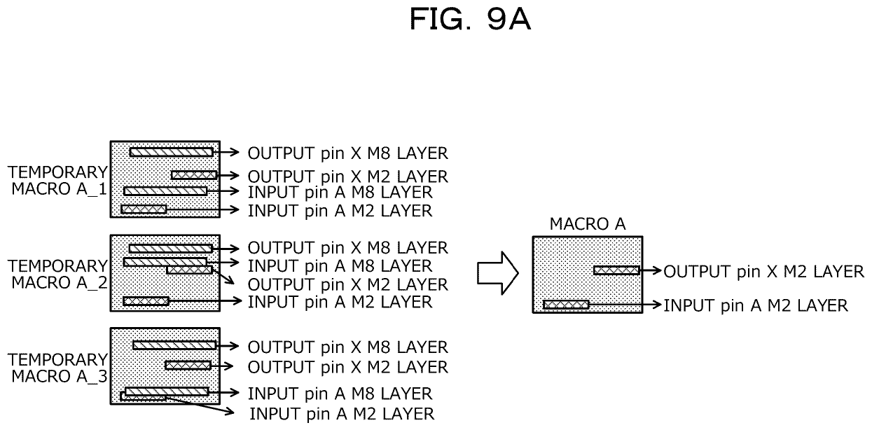

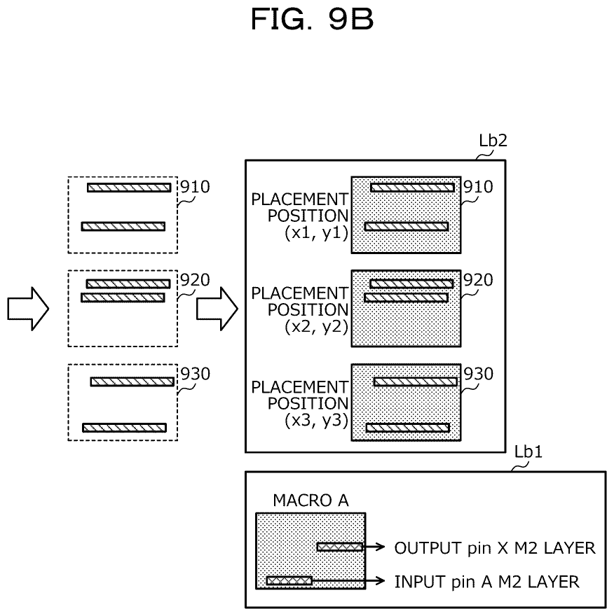

Next, a registration example of the macro library 620 will be described with reference to FIGS. 9A and 9B.

FIGS. 9A and 9B are explanatory diagrams illustrating the registration example of the macro library 620. In FIG. 9A, a case is assumed where three types of temporary macros A_1, A_2, and A_3 that may place a macro A (target macro) at a plurality of placement positions (three portions) in a design target circuit are created.

Here, a wiring layer of the macro A is the M8 layer, and terminals (an input pin A and an output pin X) exist in the M8 layer. The plurality of placement positions where the macro A may be placed in the design target circuit is determined according to a power supply structure of the design target circuit. Here, a placement position corresponding to the temporary macro A_1 is set to (x1, y1).

Furthermore, a placement position corresponding to the temporary macro A_2 is set to (x2, y2). A placement position corresponding to the temporary macro A_3 is set to (x3, y3). The placement positions of the respective temporary macros A_1, A_2, and A_3 indicate, for example, lower left coordinates of the respective temporary macros A_1, A_2, and A_3. Note that shapes of the temporary macros A_1, A_2, and A_3 are assumed to be rectangular.

The temporary macros A_1, A_2, and A_3 correspond to, for example, the three types of macros 510, 520, and 530 illustrated in FIG. 5. Note that, although a placement pattern of terminals (pins) in each of the temporary macros A_1, A_2, and A_3 exists for each layer of the bulk layer to the M8 layer, only the M2 layer and the M8 layer are indicated in FIG. 9A.

The design support server 601 extracts, based on a result of comparison of the placement patterns among the created temporary macros A_1, A_2, and A_3, a common pattern representing a portion common among the temporary macros A_1, A_2, and A_3. Here, a case is assumed where the bulk layer to the M2 layer of each of the temporary macros A_1, A_2, and A_3 are extracted as the common pattern.

In FIG. 9A, the extracted common pattern is displayed as the “macro A (formal macro)”. Note that, although a placement pattern of terminals (pins) in the macro A (formal macro) exists for each layer of the bulk layer to the M2 layer, only the M2 layer is indicated in FIG. 9A.

In FIG. 9B, the design support server 601 extracts, for each of the created temporary macros A_1, A_2, and A_3, a difference pattern (for example, VIA2 to the M8 layer) representing a difference from the extracted macro A (common pattern: the bulk layer to the M2 layer).

Here, for the temporary macro A_1, a difference pattern 910 representing a difference from the macro A (common pattern) is extracted. Furthermore, for the temporary macro A_2, a difference pattern 920 representing a difference from the macro A (common pattern) is extracted. Furthermore, for the temporary macro A_3, a difference pattern 930 representing a difference from the macro A (common pattern) is extracted.

Note that, although a placement pattern of terminals (pins) in each of the difference patterns 910, 920, and 930 exists for each layer of the VIA2 to the M8 layer, only the M8 layer is indicated in FIG. 9B.

Then, the design support server 601 registers the extracted common pattern (macro A) and the extracted difference patterns 910, 920, and 930 for the respective placement positions in the macro library 620 in association with a macro name of the macro A. For example, the macro name of the macro A is set to “MACRO_A”.

In this case, the design support server 601 registers the common pattern (macro A) as a formal macro in the physical macro library Lb1 in the macro library 620 in association with the macro name “MACRO_A”. Furthermore, the design support server 601 registers the placement position (x1, y1) and the difference pattern 910 in the module terminal generation library Lb2 in the macro library 620 in association with the macro name “MACRO_A”.

Furthermore, the design support server 601 registers the placement position (x2, y2) and the difference pattern 920 in the module terminal generation library Lb2 in the macro library 620 in association with the macro name “MACRO_A”. Furthermore, the design support server 601 registers the placement position (x3, y3) and the difference pattern 930 in the module terminal generation library Lb2 in the macro library 620 in association with the macro name “MACRO_A”.

As a result, the design support server 601 may register the common pattern (macro A) as the formal macro, and may componentize and register the difference patterns 910, 920, and 930 according to the respective placement positions (x1, y1), (x2, y2), and (x3, y3).

### (Content Stored in Module Terminal Generation Library Lb2)

Here, content stored in the module terminal generation library Lb2 in the macro library 620 will be described. First, a format example of the module terminal generation library Lb2 will be described with reference to FIG. 10. In the following description, a terminal may be referred to as a “pin”.

FIG. 10 is an explanatory diagram illustrating the format example of the module terminal generation library. In FIG. 10, a format 1000 indicates a data format of module terminal generation information stored in the module terminal generation library Lb2.

The format 1000 includes a macro name definition 1001, an intra-macro pin name definition 1002, an application use name definition 1003, a wiring layer definition 1004, a macro placement position definition 1005, a module terminal generation pattern start declaration 1006, and wiring layer name/pattern information 1007.

The macro name definition 1001 indicates a macro name of a target macro. The intra-macro pin name definition 1002 indicates a pin name (terminal name) in the target macro. The application use name definition 1003 indicates a use to be applied to the target macro. The wiring layer definition 1004 indicates an uppermost wiring layer (wiring layer for external coupling) for a pin.

The macro placement position definition 1005 indicates a placement position of the target macro. The module terminal generation pattern start declaration 1006 indicates a start declaration of a module terminal generation pattern. The wiring layer name/pattern information 1007 indicates a wiring layer name and pattern information (rectangle) of the module terminal generation pattern. The wiring layer name/pattern information 1007 corresponds to, for example, the difference patterns 910, 920, and 930 illustrated in FIG. 9B.

In the module terminal generation library Lb2, for example, the module terminal generation information in which the macro name definition 1001 to the wiring layer name/pattern information 1007 are described in a nested manner is stored.

Next, a specific example of the module terminal generation information stored in the module terminal generation library Lb2 will be described with reference to FIGS. 11A, 11B, and 11C.

FIGS. 11A, 11B, and 11C are explanatory diagrams illustrating the specific example of the module terminal generation information. In FIGS. 11A, 11B, and 11C, module terminal generation information 1100 is module terminal generation information for a pin X in the macro A (MACRO_A). MACRO: MACRO_A indicates a declaration for the MACRO_A. PIN: X indicates a declaration for the X.

The module terminal generation information 1100 includes antenna error suppression information 1110 and delay suppression information 1120. USE: ANNTENA and USE: DELAY indicate declarations for two types of uses: ANNTENA and DELAY.

The antenna error suppression information 1110 is module terminal generation information for an application use “antenna error suppression”. The antenna error suppression information 1110 includes the module terminal generation pattern start declaration 1006 and the wiring layer name/pattern information 1007 according to wiring layers “M4 and M5” and placement positions “(100, 200) and (400, 500)” of the macro A. POS: (100, 200) and POS: (400, 500) indicate declarations for (100, 200) and (400, 500). TOP_LAYER: M4 and TOP_LAYER: M5 indicate declarations for the M4 layer and the M5 layer.

The delay suppression information 1120 is module terminal generation information for an application use “delay suppression”. The delay suppression information 1120 includes the module terminal generation pattern start declaration 1006 and the wiring layer name/pattern information 1007 according to the wiring layers “M4 and M5” and the placement positions “(100, 200) and (400, 500)” of the macro A.

### (Creation Example of Module Terminal)

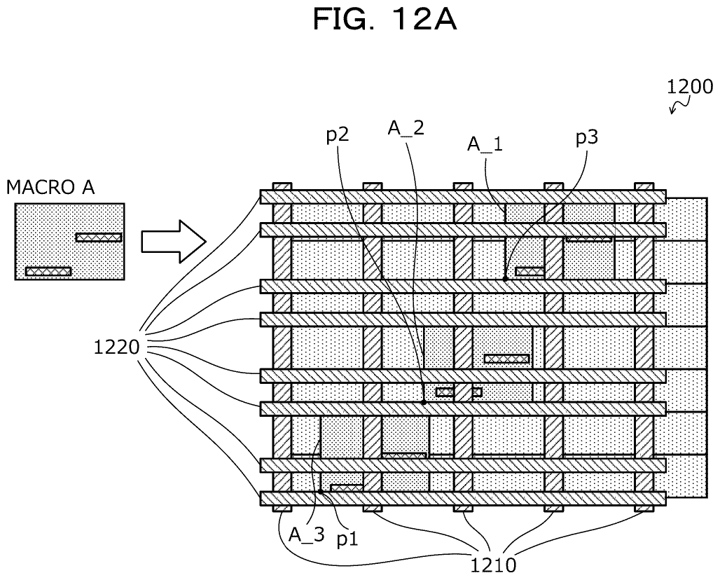

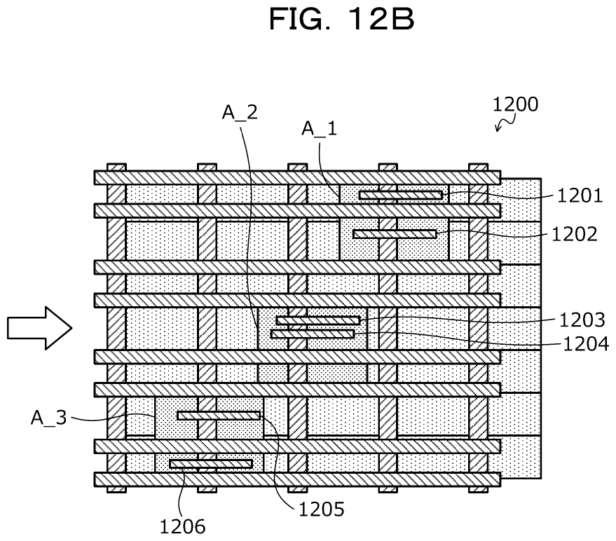

Next, a creation example of the module terminal will be described with reference to FIGS. 12A and 12B.

FIGS. 12A and 12B are explanatory diagrams illustrating the creation example of the module terminal. In FIG. 12A, a circuit 1200 is an example of a design target circuit. Here, a case is assumed where the macro A is placed in the circuit 1200. Furthermore, an uppermost wiring layer (wiring layer for external coupling) for the pins in the macro A is set to “M8 layer”.

In this case, a plurality of placement positions where the macro A may be placed is determined according to a power supply structure in the circuit 1200. Note that, in the circuit 1200, power supply wiring 1210 is an M7 power supply. Furthermore, power supply wiring 1220 is an M8 power supply.

At a stage of logic design of the circuit 1200, for example, the logic design is performed using the macro A. Note that the macro A is, for example, the common pattern (the bulk layer to the M2 layer) representing the portion common among the temporary macros A_1, A_2, and A_3 illustrated in FIG. 9A. Note that, in FIG. 12A, only the M2 layer of the macro A is indicated.

At a stage of physical design of the circuit 1200, an instance using the macro A is placed. Here, the plurality of placement positions where the macro A may be placed is set to three placement positions p1 to p3 in the circuit 1200. In this case, the design support server 601 places the respective instances A_1, A_2, and A_3 using the macro A at the placement positions p1 to p3.

In FIG. 12B, the design support server 601 lifts a module terminal for each of the instances A_1, A_2, and A_3. For example, the design support server 601 searches for, with reference to the module terminal generation library Lb2, difference patterns (for example, the difference patterns 910, 920, and 930 illustrated in FIG. 9B) according to the placement positions p1 to p3 of the respective instances A_1, A_2, and A_3.

Then, the design support server 601 creates module terminals for lifting target terminals in the respective instances A_1, A_2, and A_3 based on the retrieved difference patterns. Here, the respective module terminals 1201 and 1202 (lifting module terminals) with the same layer, the same shape, and the same placement position are created for the respective pins (lifting target terminals (not illustrated)) of the M8 layer of the instance A_1.

Furthermore, the respective module terminals 1203 and 1204 with the same layer, the same shape, and the same placement position are created for the respective pins of the M8 layer of the instance A_2. Furthermore, the respective module terminals 1205 and 1206 with the same layer, the same shape, and the same placement position are created for the respective pins of the M8 layer of the instance A_3. Note that, in FIG. 12B, only the module terminals 1201 to 1206 of the M8 layers of the respective instances A_1, A_2, and A_3 are indicated.

As a result, the design support server 601 may place the module terminals (1201 to 1206) at the positions expected by the macro designer even in a case where cell terminals are placed in the upper layer (M8 layer) when the macro A is placed in the circuit 1200 having the complicated power supply structure. Furthermore, the design support server 601 may set coupling to the module terminals (1201 to 1206) to an assumed shape of the macro designer.

### (Library Creation Processing Procedure of Design Support Server 601)

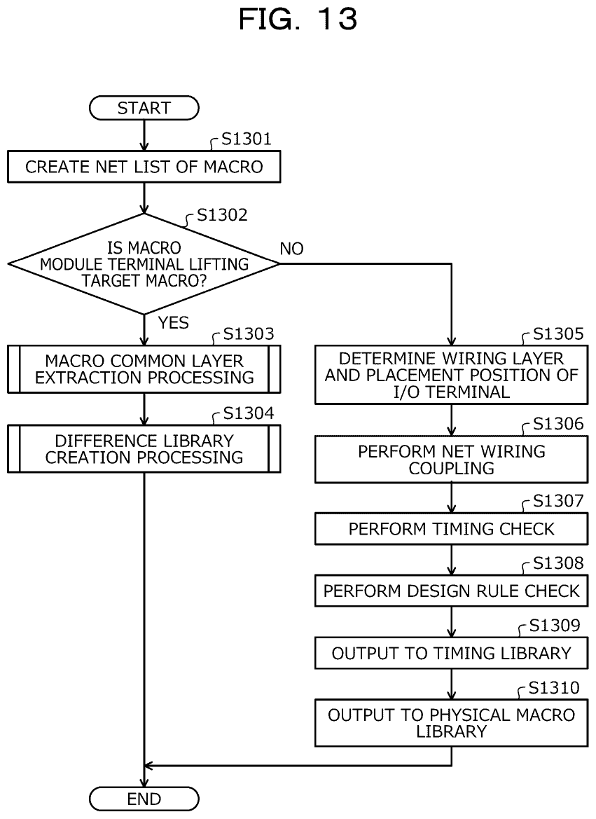

Next, a library creation processing procedure of the design support server 601 will be described with reference to FIG. 13.

FIG. 13 is a flowchart illustrating an example of the library creation processing procedure of the design support server 601. In the flowchart of FIG. 13, first, based on circuit information of a macro placed in a design target circuit, the design support server 601 creates a net list of the macro (step S1301).

Next, the design support server 601 determines whether or not the macro (macro currently being processed) is a module terminal lifting target macro (step S1302). For example, a macro name of the module terminal lifting target macro is set in advance. In this case, the design support server 601 determines whether or not the macro is the module terminal lifting target macro based on, for example, whether or not a macro name of the macro is the macro name of the module terminal lifting target macro, which is set in advance.

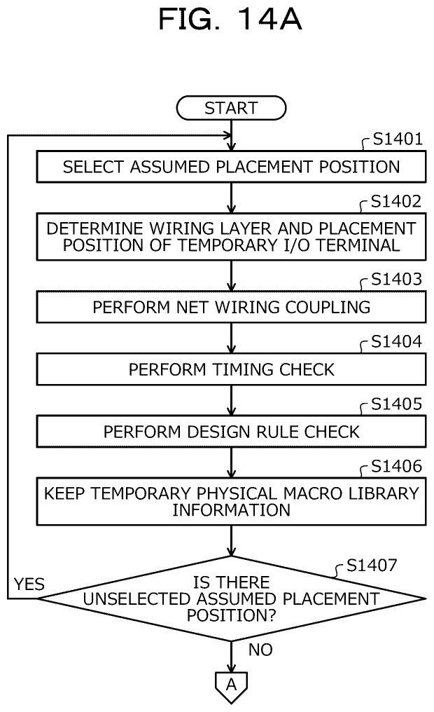

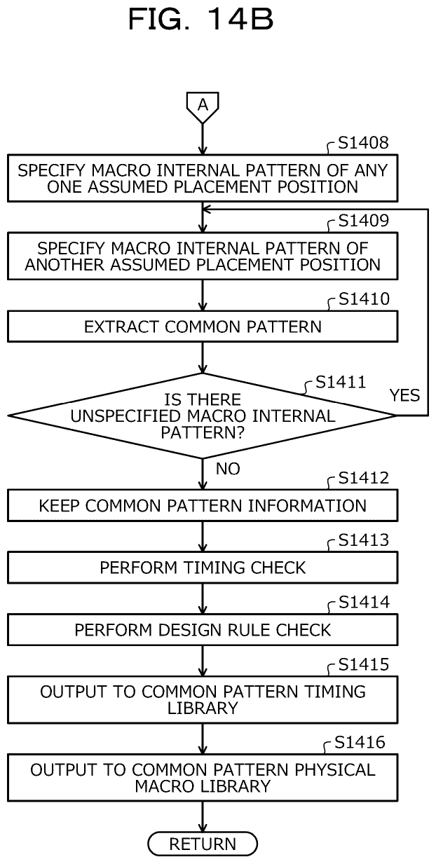

Here, in the case of the module terminal lifting target macro (step S1302: Yes), the design support server 601 executes macro common layer extraction processing (step S1303). A specific processing procedure of the macro common layer extraction processing will be described later with reference to FIGS. 14A and 14B.

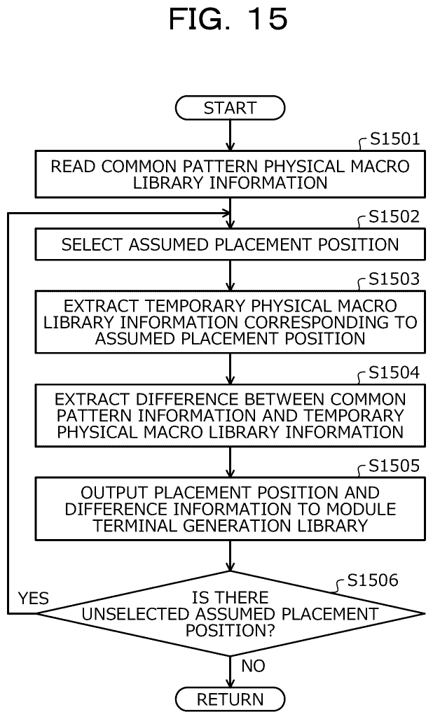

Then, the design support server 601 executes difference library creation processing (step S1304), and ends a series of processing according to the present flowchart. A specific processing procedure of the difference library creation processing will be described later with reference to FIG. 15.

Furthermore, in the case of not the module terminal lifting target macro in step S1302 (step S1302: No), the design support server 601 determines a wiring layer and a placement position of an I/O terminal in the macro (Step S1305). Next, the design support server 601 performs net wiring coupling in the macro (step S1306).

Then, the design support server 601 performs a timing check of the macro (step S1307). Next, the design support server 601 performs a design rule check of the macro (step S1308). Note that, in the case of a timing error or design rule violation, for example, description or a restriction condition of the macro is changed, and the macro is created again.

Then, the design support server 601 outputs a timing check result of the macro to a timing library (step S1309). Note that the timing library (not illustrated) stores information related to a timing of the macro. The timing library is included in, for example, the macro library 620.

Next, the design support server 601 outputs physical macro library information of the created macro to the physical macro library Lb1 (step S1310), and ends the series of processing according to the present flowchart. The physical macro library information is design information (a logical function, the wiring layer and the placement position of the I/O terminal, and the like) related to the macro.

As a result, the design support server 601 may create the macro library 620 in which various macros (cells) to be placed in the design target circuit are registered.

Next, a specific processing procedure of the macro common layer extraction processing in step S1303 indicated in FIG. 13 will be described with reference to FIGS. 14A and 14B.

FIGS. 14A and 14B are flowcharts illustrating an example of the specific processing procedure of the macro common layer extraction processing. In the flowchart of FIG. 14A, first, the design support server 601 selects an unselected assumed placement position that has not been selected among assumed placement positions in the design target circuit (step S1401).

Note that the assumed placement position corresponds to a placement position where the macro may be placed according to a power supply structure of the design target circuit. Here, the macro corresponding to the assumed placement position is referred to as a “temporary macro”.

Next, the design support server 601 determines a wiring layer and a placement position of a temporary I/O terminal in the temporary macro in consideration of a restriction condition specified in advance (step S1402). Next, the design support server 601 performs net wiring coupling in the temporary macro (step S1403).

Then, the design support server 601 performs a timing check of the temporary macro (step S1404). Next, the design support server 601 performs a design rule check of the temporary macro (step S1405).

Then, the design support server 601 keeps temporary physical macro library information of the created temporary macro (step S1406). The temporary physical macro library information is design information (a macro name, a logical function, the wiring layer and the placement position of the I/O terminal, a net representing a coupling relationship between terminals, and the like) related to the temporary macro.

Next, the design support server 601 determines whether or not there is an unselected assumed placement position that has not been selected among the assumed placement positions in the design target circuit (step S1407). Here, in a case where there is an unselected assumed placement position (step S1407: Yes), the design support server 601 returns to step S1401.

On the other hand, in a case where there is no unselected assumed placement position (step S1407: No), the design support server 601 proceeds to step S1408 indicated in FIG. 14B.

In the flowchart of FIG. 14B, first, the design support server 601 specifies a macro internal pattern of any one assumed placement position among the assumed placement positions in the design target circuit (step S1408). The macro internal pattern corresponds to a placement pattern of terminals of each layer in the temporary macro.

Next, the design support server 601 specifies a macro internal pattern of another assumed placement position among the assumed placement positions in the design target circuit (step S1409). Then, the design support server 601 extracts a common pattern based on a result of comparison between the specified macro internal patterns (step S1410).

Next, the design support server 601 determines whether or not there is an unspecified macro internal pattern of an assumed placement position (step S1411). Here, in a case where there is an unspecified macro internal pattern of an assumed placement position (step S1411: Yes), the design support server 601 returns to step S1409.

On the other hand, in a case where there is no unspecified macro internal pattern of an assumed placement position (step S1411: No), the design support server 601 keeps common pattern information (step S1412). The common pattern information represents the common pattern extracted in step S1410. The common pattern represents a portion common among all macro internal patterns.

Next, the design support server 601 performs a timing check of the common pattern (step S1413). Then, the design support server 601 performs a design rule check of the common pattern (step S1414). Next, the design support server 601 outputs a timing check result (capacitance of a terminal, a timing, and the like) of the common pattern to the timing library (step S1415).

Then, the design support server 601 outputs common pattern physical macro library information to the physical macro library Lb1 (step S1416), and returns to the step in which the macro common layer extraction processing has been called. The common pattern physical macro library information is design information (a macro name, a logical function, a placement position of an I/O terminal, a net, and the like) related to the common pattern.

As a result, the design support server 601 may extract the common pattern representing the portion common among the temporary macros and register the common pattern in the physical macro library Lb1.

Next, a specific processing procedure of the difference library creation processing in step S1304 indicated in FIG. 13 will be described with reference to FIG. 15.

FIG. 15 is a flowchart illustrating an example of the specific processing procedure of the difference library creation processing. In the flowchart of FIG. 15, first, the design support server 601 reads the common pattern physical macro library information from the physical macro library Lb1 (step S1501).

Next, the design support server 601 selects an unselected assumed placement position that has not been selected among the assumed placement positions in the design target circuit (step S1502). Then, the design support server 601 extracts the temporary physical macro library information corresponding to the selected assumed placement position among the pieces of temporary physical macro library information kept in step S1406 (step S1503).

Next, the design support server 601 extracts difference information (difference pattern) representing a difference between the read common pattern physical macro library information and the extracted temporary physical macro library information (step S1504). Then, the design support server 601 outputs the selected placement position (assumed placement position) and the extracted difference information to the module terminal generation library Lb2 in the macro library 620 (step S1505).

Next, the design support server 601 determines whether or not there is an unselected assumed placement position that has not been selected among the assumed placement positions in the design target circuit (step S1506). Here, in a case where there is an unselected assumed placement position (step S1506: Yes), the design support server 601 returns to step S1502.

On the other hand, in a case where there is no unselected assumed placement position (step S1506: No), the design support server 601 returns to the step in which the difference library creation processing has been called.

As a result, the design support server 601 may extract the difference from the common pattern for each temporary macro for each assumed placement position, and register the difference in the module terminal generation library Lb2.

### (Module Terminal Lifting Processing Procedure of Design Support Server 601)

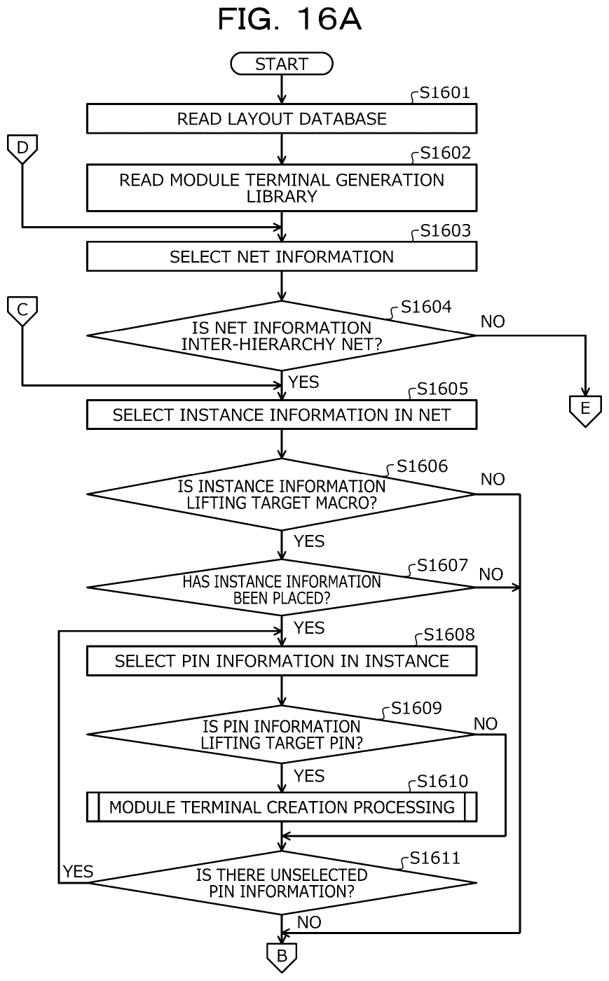

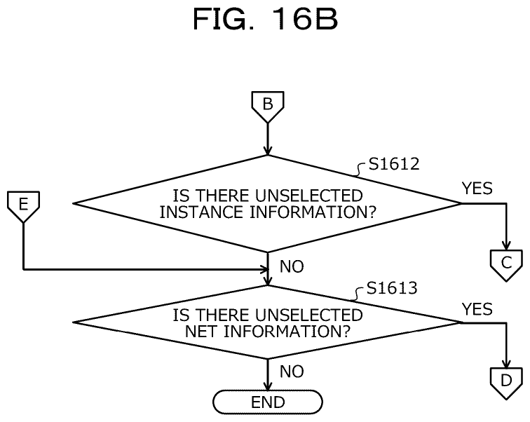

Next, a module terminal lifting processing procedure of the design support server 601 will be described with reference to FIGS. 16A and 16B.

FIGS. 16A and 16B are flowcharts illustrating an example of the module terminal lifting processing procedure of the design support server 601. In the flowchart of FIG. 16A, first, the design support server 601 reads the layout database 630 (step S1601). Next, the design support server 601 reads the module terminal generation library Lb2 (step S1602).

Then, the design support server 601 selects, with reference to the layout database 630, unselected net information that has not been selected among pieces of net information of the design target circuit (step S1603). Next, the design support server 601 determines whether or not the selected net information is an inter-hierarchy net (step S1604). The inter-hierarchy net is a net coupled to the outside of the design target circuit.

Here, in the case of not the inter-hierarchy net (step S1604: No), the design support server 601 proceeds to step S1613 indicated in FIG. 16B. On the other hand, in the case of the inter-hierarchy net (S1604:Yes), the design support server 601 selects, with reference to the layout database 630, unselected instance information that has not been selected among pieces of instance information in the net (step S1605). The instance information in the net represents a macro (cell) coupled to the net.

Next, the design support server 601 determines whether or not the selected instance information is a lifting target macro (step S1606). The lifting target macro is, for example, a macro coupled to the clock net, and is specified in advance. Here, in the case of not the lifting target macro (step S1606: No), the design support server 601 proceeds to step S1612 indicated in FIG. 16B.

On the other hand, in the case of the lifting target macro (step S1606: Yes), the design support server 601 determines whether or not the selected instance information has been placed (step S1607). Here, in a case where the instance information has not been placed (step S1607: No), the design support server 601 proceeds to step S1612 indicated in FIG. 16B.

On the other hand, in a case where the instance information has been placed (S1607:Yes), the design support server 601 selects unselected pin information that has not been selected among pieces of pin information in the instance (step S1608). Then, the design support server 601 determines whether or not the selected pin information is a lifting target pin (step S1609). The lifting target pin is specified in advance, for example.

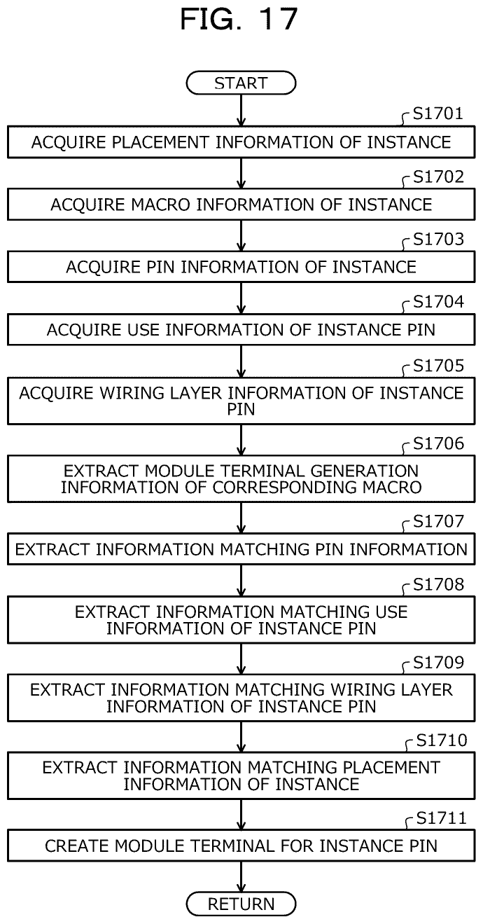

Here, in the case of not the lifting target pin (step S1609: No), the design support server 601 proceeds to step S1611. On the other hand, in the case of the lifting target pin (step S1609: Yes), the design support server 601 executes module terminal creation processing (step S1610). A specific processing procedure of the module terminal creation processing will be described later with reference to FIG. 17.

Next, the design support server 601 determines whether or not there is unselected pin information that has not been selected among the pieces of pin information in the instance (step S1611). Here, in a case where there is unselected pin information (step S1611: Yes), the design support server 601 returns to step S1608.

On the other hand, in a case where there is no unselected pin information (step S1611: No), the design support server 601 proceeds to step S1612 indicated in FIG. 16B.

In the flowchart of FIG. 16B, first, the design support server 601 determines whether or not there is unselected instance information that has not been selected among the pieces of the instance information in the net (step S1612). Here, in a case where there is unselected instance information (step S1612: Yes), the design support server 601 returns to step S1605 indicated in FIG. 16A.

On the other hand, in a case where there is no unselected instance information (step S1612: No), the design support server 601 determines whether or not there is unselected net information that has not been selected among the pieces of net information of the design target circuit (step S1613). Here, in a case where there is unselected net information (step S1613: Yes), the design support server 601 returns to step S1603 indicated in FIG. 16A.

On the other hand, in a case where there is no unselected net information (step S1613: No), the design support server 601 ends a series of processing according to the present flowchart.

Next, a specific processing procedure of the module terminal creation processing in step S1610 indicated in FIG. 16A will be described with reference to FIG. 17.

FIG. 17 is a flowchart illustrating an example of the specific processing procedure of the module terminal creation processing. In the flowchart of FIG. 17, first, the design support server 601 acquires placement information of an instance (step S1701). Note that the instance is an instance specified from the instance information selected in step S1605 indicated in FIG. 16A.

Next, the design support server 601 acquires macro information (for example, a macro name) of the instance (step S1702). Next, the design support server 601 acquires pin information (for example, a pin name) of the instance (step S1703).

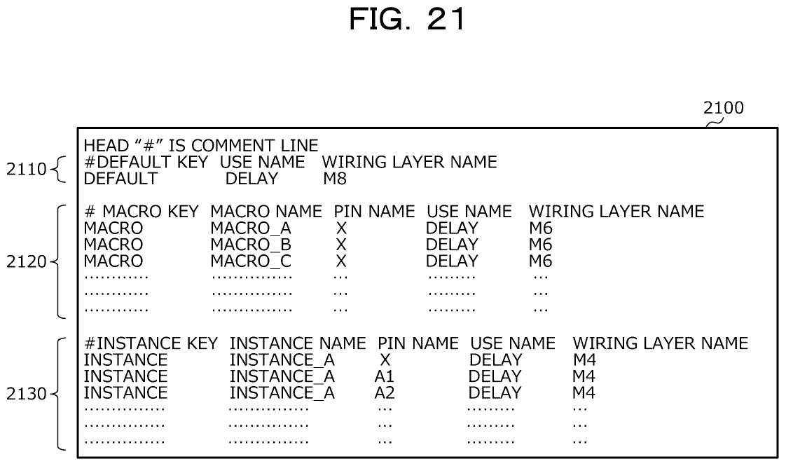

Then, the design support server 601 acquires use information of an instance pin (step S1704). The instance pin is a pin in the instance (macro). The use information of the instance pin is set in advance, for example. Note that the use information of the instance pin may be acquired from a control file to be described later. The control file is a parameter file related to lifting control of a module terminal. Note that a specific example of the control file will be described later with reference to FIG. 21.

Next, the design support server 601 acquires wiring layer information of the instance pin (step S1705). The wiring layer information of the instance pin is set in advance, for example. Note that the wiring layer information of the instance pin may be acquired from the control file to be described later.

Then, the design support server 601 extracts, from the module terminal generation library Lb2, module terminal generation information of the corresponding macro corresponding to the acquired macro information (step S1706).

Next, the design support server 601 extracts information matching the acquired pin information from the extracted module terminal generation information (step S1707). Then, the design support server 601 extracts information matching the acquired use information of the instance pin from the information extracted in step S1707 (step S1708).

Next, the design support server 601 extracts information matching the wiring layer information of the instance pin from the information extracted in step S1708 (step S1709). Next, the design support server 601 extracts information matching the acquired placement position information from the information extracted in step S1709 (step S1710).

Then, the design support server 601 creates a module terminal for the instance pin based on the information extracted in step S1710 (step S1711), and returns to the step in which the module terminal creation processing has been called.

As a result, the design support server 601 may create the module terminal for the lifting target pin in the macro.

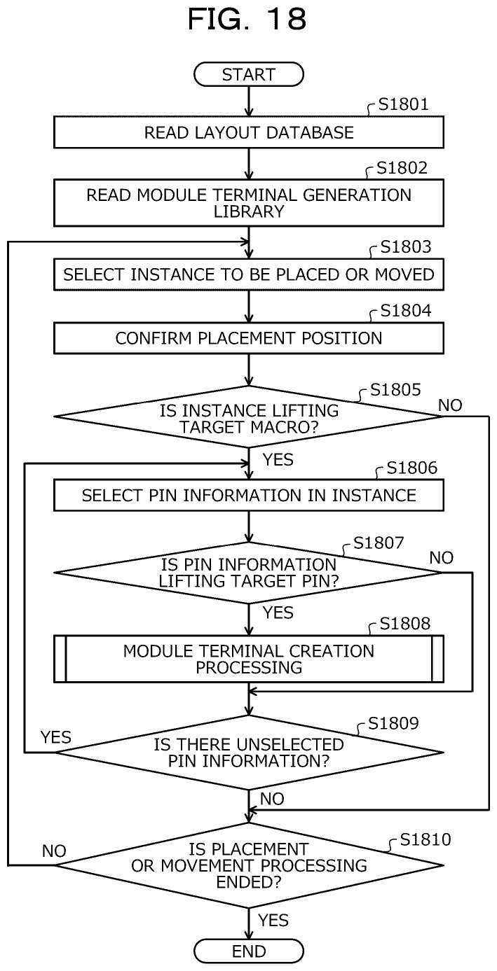

Next, a module terminal lifting processing procedure (interactive editor) of the design support server 601 will be described with reference to FIG. 18. The interactive editor is processing for creating a module terminal in an interactive manner (conversational manner) with a user.

FIG. 18 is a flowchart illustrating an example of the module terminal lifting processing procedure (interactive editor) of the design support server 601. In the flowchart of FIG. 18, first, the design support server 601 reads the layout database 630 (step S1801). Next, the design support server 601 reads the module terminal generation library Lb2 (step S1802).

Then, the design support server 601 selects an instance to be placed or moved by a user operation (step S1803). Next, the design support server 601 confirms a placement position of the selected instance by a user operation (step S1804).

Then, the design support server 601 determines whether or not the selected instance is a lifting target macro (step S1805). Here, in the case of not the lifting target macro (step S1805: No), the design support server 601 proceeds to step S1810.

On the other hand, in the case of the lifting target macro (S1805:Yes), the design support server 601 selects unselected pin information that has not been selected among pieces of pin information in the instance (step S1806). Then, the design support server 601 determines whether or not the selected pin information is a lifting target pin (step S1807).

Here, in the case of not the lifting target pin (step S1807: No), the design support server 601 proceeds to step S1809. On the other hand, in the case of the lifting target pin (step S1807: Yes), the design support server 601 executes module terminal creation processing (step S1808).

Note that since a specific processing procedure of the module terminal creation processing is similar to the processing procedure illustrated in FIG. 17, illustration and description are omitted.

Next, the design support server 601 determines whether or not there is unselected pin information that has not been selected among the pieces of pin information in the instance (step S1809). Here, in a case where there is unselected pin information (step S1809: Yes), the design support server 601 returns to step S1806.

On the other hand, in a case where there is no unselected pin information (step S1809: No), the design support server 601 determines whether or not placement or movement processing is ended (step S1810). Here, in a case where the placement or movement processing is not ended (step S1810: No), the design support server 601 returns to step S1803.

On the other hand, in a case where the placement or movement processing is ended (step S1810: Yes), the design support server 601 ends a series of processing according to the present flowchart.

As a result, the design support server 601 may create the module terminal for the lifting target pin in the macro in the interactive manner (conversational manner) with a user.

### First Example

Next, a first example will be described. In the first example, a case will be described where the macro library 620 is created according to a use to be applied to a target macro. The macro library 620 may be created according to, for example, the use such as antenna error suppression, electromigration suppression, or delay suppression.

Here, a library creation processing procedure of the design support server 601, for creating the macro library 620 according to an application use will be described. Note that a basic processing procedure of the library creation processing is similar to the library creation processing procedure illustrated in FIG. 13. Here, in the library creation processing procedure illustrated in FIG. 13, regarding the macro common layer extraction processing in step S1303 and the difference library creation processing in step S1304, processing procedures in consideration of the application use will be described.

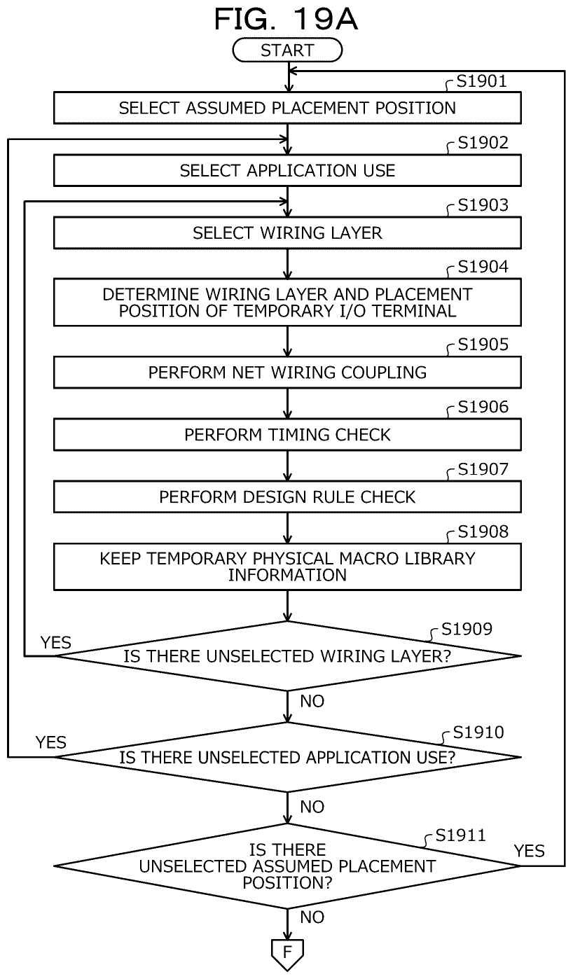

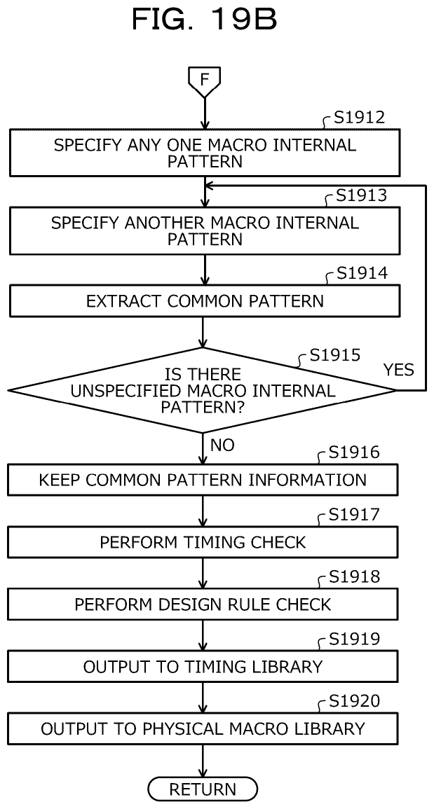

First, a specific processing procedure of the macro common layer extraction processing according to the first example will be described with reference to FIGS. 19A and 19B.

FIGS. 19A and 19B are flowcharts illustrating an example of the specific processing procedure of the macro common layer extraction processing according to the first example. In the flowchart of FIG. 19A, first, the design support server 601 selects an unselected assumed placement position that has not been selected among assumed placement positions in the design target circuit (step S1901).

Next, the design support server 601 selects an unselected use (application use) that has not been selected among a plurality of uses applicable to the macro (step S1902). Next, the design support server 601 selects an unselected wiring layer that has not been selected among a plurality of wiring layers for external coupling applicable to the macro (step S1903).

Then, the design support server 601 determines a wiring layer and a placement position of a temporary I/O terminal in a temporary macro according to the selected wiring layer in consideration of a restriction condition corresponding to the selected application use (step S1904). Next, the design support server 601 performs net wiring coupling in the temporary macro (step S1905).

Then, the design support server 601 performs a timing check of the temporary macro (step S1906). Next, the design support server 601 performs a design rule check of the temporary macro (step S1907). Then, the design support server 601 keeps temporary physical macro library information of the created temporary macro (step S1908).

Next, the design support server 601 determines whether or not there is an unselected wiring layer that has not been selected among the plurality of wiring layers (step S1909). Here, in a case where there is an unselected wiring layer (step S1909: Yes), the design support server 601 returns to step S1903.

On the other hand, in a case where there is no unselected wiring layer (step S1909: No), the design support server 601 determines whether or not there is an unselected use (application use) that has not been selected among the plurality of uses (step S1910). Here, in a case where there is an unselected application use (step S1910: Yes), the design support server 601 returns to step S1902.

On the other hand, in a case where there is no unselected application use (step S1910: No), the design support server 601 determines whether or not there is an unselected assumed placement position that has not been selected among the assumed placement positions in the design target circuit (step S1911). Here, in a case where there is an unselected assumed placement position (step S1911: Yes), the design support server 601 returns to step S1901.

On the other hand, in a case where there is no unselected assumed placement position (step S1911: No), the design support server 601 proceeds to step S1912 indicated in FIG. 19B.

In the flowchart of FIG. 19B, first, the design support server 601 specifies a macro internal pattern corresponding to any combination of the assumed placement position, the application use, and the wiring layer (step S1912). Next, the design support server 601 specifies a macro internal pattern corresponding to any other combination of the assumed placement position, the application use, and the wiring layer (step S1913).

Then, the design support server 601 extracts a common pattern based on a result of comparison between the specified macro internal patterns (step S1914). Next, the design support server 601 determines whether or not there is an unspecified macro internal pattern of an assumed placement position (step S1915).

Here, in a case where there is an unspecified macro internal pattern of an assumed placement position (step S1915: Yes), the design support server 601 returns to step S1913. On the other hand, in a case where there is no unspecified macro internal pattern of an assumed placement position (step S1915: No), the design support server 601 keeps common pattern information (step S1916).

Next, the design support server 601 performs a timing check of the common pattern (step S1917). Then, the design support server 601 performs a design rule check of the common pattern (step S1918). Next, the design support server 601 outputs a timing check result of the common pattern to the timing library (step S1919).

Then, the design support server 601 outputs common pattern physical macro library information to the physical macro library Lb1 (step S1920), and returns to the step in which the macro common layer extraction processing has been called.

As a result, the design support server 601 may create the plurality of temporary macros in consideration of the assumed placement position, the application use, and the wiring layer of the target macro, extract the common pattern representing the portion common among the temporary macros, and register the common pattern in the physical macro library Lb1.

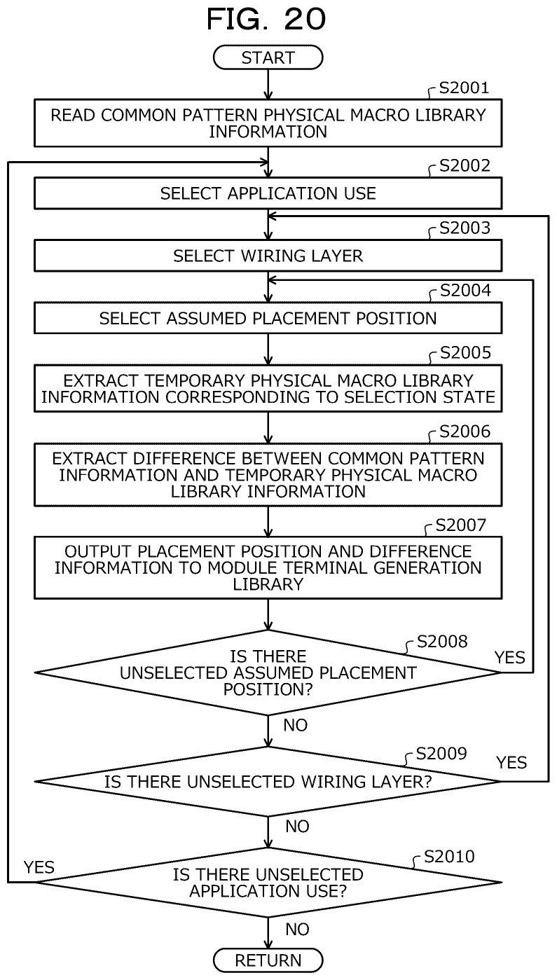

Next, a specific processing procedure of the difference library creation processing according to the first example will be described with reference to FIG. 20.

FIG. 20 is a flowchart illustrating an example of the specific processing procedure of the difference library creation processing according to the first example. In the flowchart of FIG. 20, first, the design support server 601 reads the common pattern physical macro library information from the physical macro library Lb1 (step S2001).

Next, the design support server 601 selects an unselected use (application use) that has not been selected among the plurality of applicable uses (step S2002). Next, the design support server 601 selects an unselected wiring layer that has not been selected among the plurality of applicable wiring layers for external coupling (step S2003).

Next, the design support server 601 selects an unselected assumed placement position that has not been selected among the assumed placement positions in the design target circuit (step S2004). Then, the design support server 601 extracts the temporary physical macro library information corresponding to a selection state of the application use, the wiring layer, and the assumed placement position from the temporary physical macro library information kept in step S1908 (step S2005).

Next, the design support server 601 extracts difference information (difference pattern) representing a difference between the read common pattern physical macro library information and the extracted temporary physical macro library information (step S2006). Then, the design support server 601 outputs the selected placement position (assumed placement position) and the extracted difference information to the module terminal generation library Lb2 in the macro library 620 (step S2007).

Next, the design support server 601 determines whether or not there is an unselected assumed placement position that has not been selected among the assumed placement positions in the design target circuit (step S2008). Here, in a case where there is an unselected assumed placement position (step S2008: Yes), the design support server 601 returns to step S2004.

On the other hand, in a case where is no unselected assumed placement position (step S2008: No), the design support server 601 determines whether or not there is an unselected wiring layer that has not been selected among the plurality of wiring layers (step S2009). Here, in a case where there is an unselected wiring layer (step S2009: Yes), the design support server 601 returns to step S2003.

On the other hand, in a case where there is no unselected wiring layer (step S2009: No), the design support server 601 determines whether or not there is an unselected use (application use) that has not been selected among the plurality of uses (step S2010). Here, in a case where there is an unselected application use (step S2010: Yes), the design support server 601 returns to step S2002.

On the other hand, in a case where there is no unselected application use (step S2010: No), the design support server 601 returns to the step in which the difference library creation processing has been called.

As a result, the design support server 601 may extract the difference from the common pattern for each temporary macro created in consideration of the assumed placement position, the application use, and the wiring layer, and register the difference in the module terminal generation library Lb2.

According to the first example, the design support server 601 may create the macro library 620 according to the use such as antenna error suppression, electromigration suppression, or delay suppression.

### Second Example

Next, a second example will be described. In the second example, a control file will be described. The control file is a parameter file for defining a use and a wiring layer to be applied to a macro. For example, the design support server 601 may accept an input of the control file from the client terminal 602. Furthermore, for example, the design support server 601 may accept the input of the control file by an operation input from a user using an input device (not illustrated).

FIG. 21 is an explanatory diagram illustrating a specific example of the control file. In FIG. 21, a control file 2100 includes default information 2110, macro setting information 2120, and instance setting information 2130.

The default information 2110 indicates a use name and a wiring layer to be applied in default setting. The default information 2110 is applied to an instance pin that is not defined by a macro key or an instance key. Here, in the default information 2110, use: DELAY, and wiring layer: M8 are defined.

The macro setting information 2120 is setting for a macro, and defines a macro name, a pin name, a use name, and a wiring layer name. The macro setting information 2120 is applied to an instance pin that is not defined by an instance key. Here, in the macro setting information 2120, MACRO_A, use for pin X: DELAY, and wiring layer: M6 are defined. Furthermore, MACRO_B, use for pin X: DELAY, and wiring layer: M6 are defined. Furthermore, MACRO_C, use for pin X: DELAY, and wiring layer: M6 are defined.

The instance setting information 2130 is setting for an instance, and defines an instance name, a pin name, a use name, and a wiring layer name. Here, in the instance setting information 2130, INSTANCE_A, use for pin X: DELAY, and wiring layer: M4 are defined. Furthermore, INSTANCE_A, use for pin A1: DELAY, and wiring layer: M4 are defined. Furthermore, INSTANCE_A, use for pin A2: DELAY, and wiring layer: M4 are defined.

The design support server 601 may control lifting of a module terminal by referring to the control file 2100, for example.

Note that, in order for a designer to create the control file (for example, the control file 2100), it is needed to recognize a parameter output to the module terminal generation library Lb2 and recognize an instance, a library cell, and the like in a design target circuit (for example, a lower hierarchy of hierarchically designed LSI). Thus, it may be difficult for some designers to create the control file.

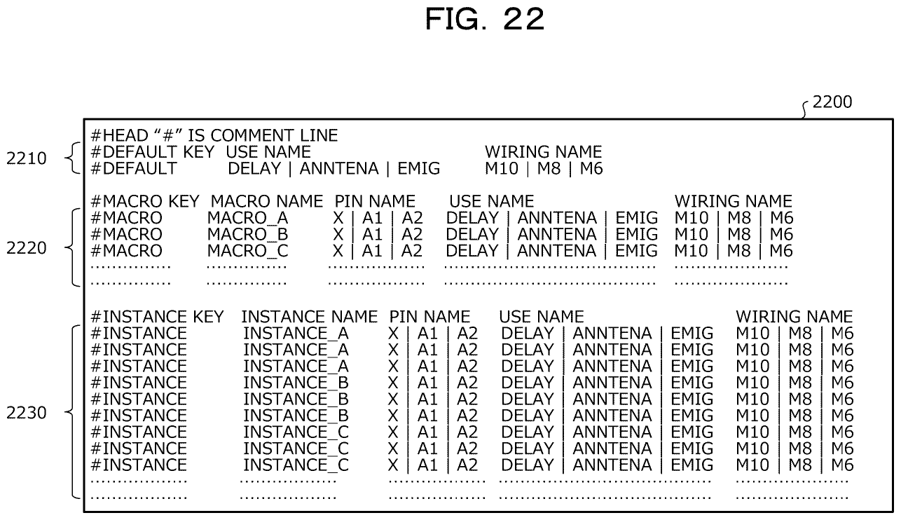

Therefore, a method of supporting creation of the control file will be described. First, a method of supporting creation of the control file by creating a template file that may be easily edited by a designer will be described with reference to FIG. 22.

FIG. 22 is an explanatory diagram illustrating an example of a control file template. In FIG. 22, a control file template 2200 is an example of a template of the control file. A head # of the control file template 2200 is handled as a comment line. In the control file template 2200, all pieces of information are output in comment lines (edited by the designer as needed later).

The control file template 2200 includes default setting information 2210, macro information 2220, and instance information 2230. The macro pin information (all types of uses and wiring layers) used in the layout database 630 is output to the default setting information 2210.

Furthermore, for only the macro pin information used in the layout database 630, a use and wiring layer information are output to the macro information 2220. Furthermore, for only the macro pin information used in the layout database 630, a use and wiring layer information are output to the instance information 2230.

By creating a control file according to a design target circuit while editing the control file template 2200, the designer may reduce a work load and a work time as compared with a case of creating the control file from scratch. For example, the designer may easily create a desired control file by deleting unnecessary information from the control file template 2200.

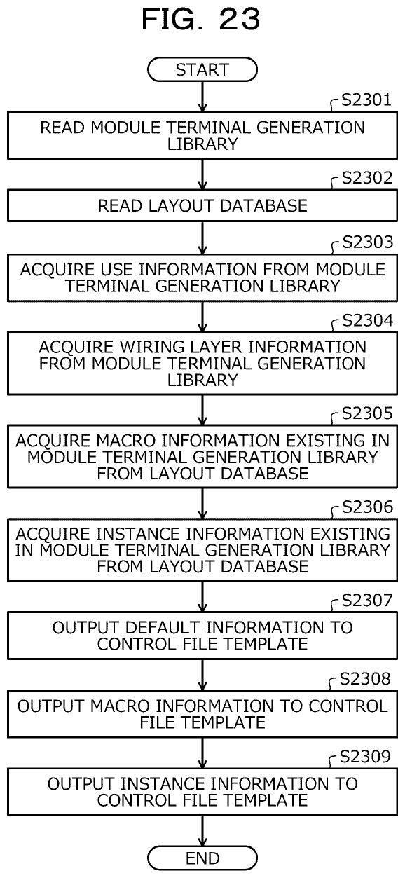

Here, a control file template creation processing procedure of the design support server 601 will be described with reference to FIG. 23.

FIG. 23 is a flowchart illustrating an example of the control file template creation processing procedure of the design support server 601. In the flowchart of FIG. 23, first, the design support server 601 reads the module terminal generation library Lb2 (step S2301). Next, the design support server 601 reads the layout database 630 (step S2302).

Then, the design support server 601 acquires use information from the module terminal generation library Lb2 (step S2303). Next, the design support server 601 acquires wiring layer information from the module terminal generation library Lb2 (step S2304).

Then, the design support server 601 acquires macro information existing in the module terminal generation library Lb2 from the layout database 630 (step S2305). Next, the design support server 601 acquires instance information existing in the module terminal generation library Lb2 from the layout database 630 (step S2306).

Next, the design support server 601 outputs default information to a control file template based on the acquired various types of information (step S2307). Next, the design support server 601 outputs the macro information to the control file template based on the acquired various types of information (step S2308).

Then, the design support server 601 outputs the instance information to the control file template based on the acquired various types of information (step S2309), and ends a series of processing according to the present flowchart.

As a result, the design support server 601 may create the control file template that may be easily edited by a designer, and may support creation of a control file by the designer.

Next, a method of supporting creation of the control file by an interactive editor will be described. Here, various operation screens displayed on the client terminal 602 when the control file is created with the interactive editor will be described. A user of the client terminal 602 is, for example, a designer of a design target circuit.

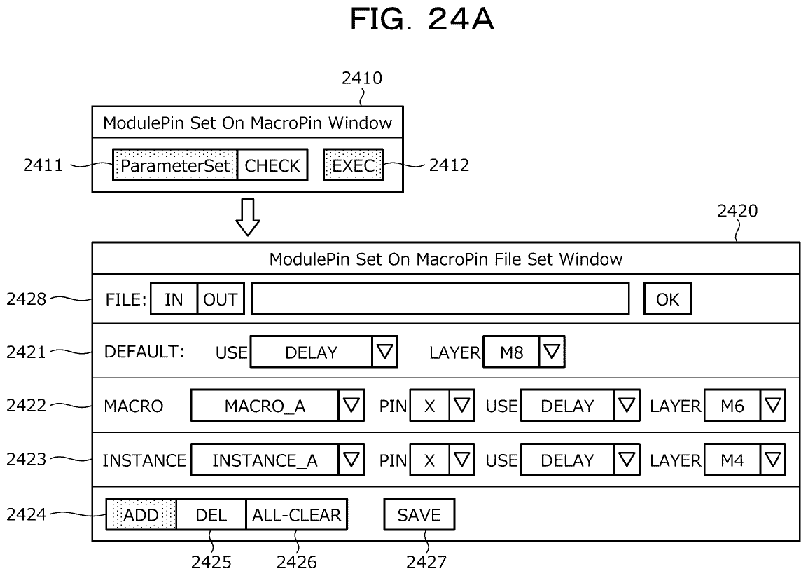

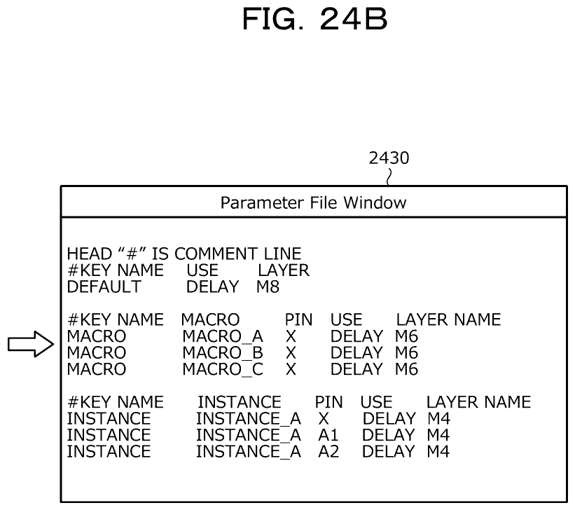

FIGS. 24A and 24B are explanatory diagrams illustrating an example of the operation screen related to the creation of the control file. In FIG. 24A, ModulePin Set On MacroPin Window 2410 is an example of the operation screen displayed when the control file is created.

In the ModulePin Set On MacroPin Window 2410, when ParameterSet 2411 is selected and EXEC 2412 is pressed by an operation input from the user, parameter setting Window 2420 (ModulePin Set On MacroPin File Set Window) is displayed.

In the parameter setting Window 2420, various types of information of “DEFAULT” may be set by operating a DEFAULT field 2421 by an operation input from the user. Furthermore, in the parameter setting Window 2420, various types of information of “MACRO” may be set by operating a MACRO field 2422 by an operation input from the user.

Furthermore, in the parameter setting Window 2420, various types of information of “INSTANCE” may be set by operating an INSTANCE field 2423 by an operation input from the user. In each item in the categories (fields) of “DEFAULT”, “MACRO”, and “INSTANCE”, for example, information extracted from the layout database 630 or the module terminal generation library Lb2 may be selected.

In the parameter setting Window 2420, when ADD 2424 is pressed by an operation input from the user, Parameter File Window 2430 as illustrated in FIG. 24B is displayed. In the Parameter File Window 2430, information set in each of the fields 2421 to 2423 is displayed.

Furthermore, in the parameter setting Window 2420, when DEL 2425 is pressed by an operation input from the user, the information (selection information) set in each of the fields 2421 to 2423 may be deleted. Furthermore, in the parameter setting Window 2420, when ALL-CLEAR 2426 is pressed by an operation input from the user, all pieces of the information set in each of the fields 2421 to 2423 may be deleted.

Furthermore, in the parameter setting Window 2420, when SAVE 2427 is pressed by an operation input from the user, information set in layout data may be reflected. Furthermore, in the parameter setting Window 2420, when a file name is input into a FILE field 2428 and “OUT” and “OK” are pressed by an operation input from the user, the file name may be output to the control file.

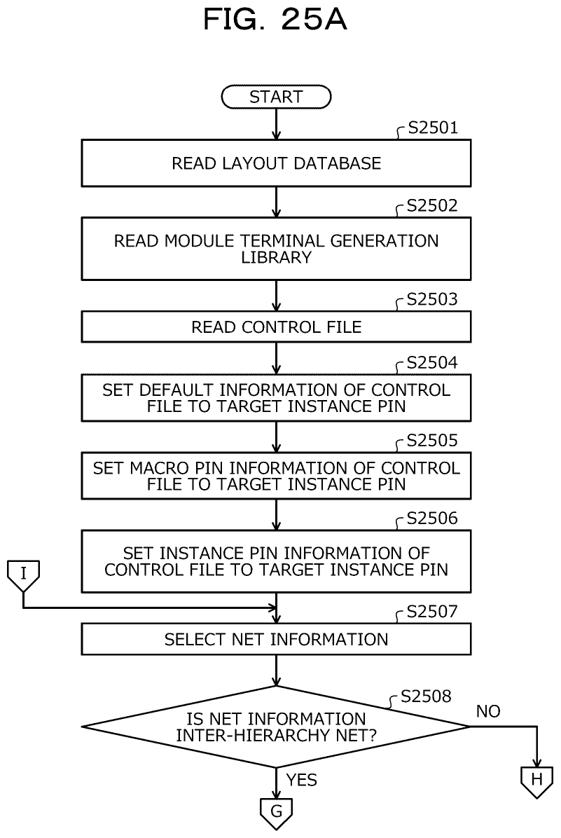

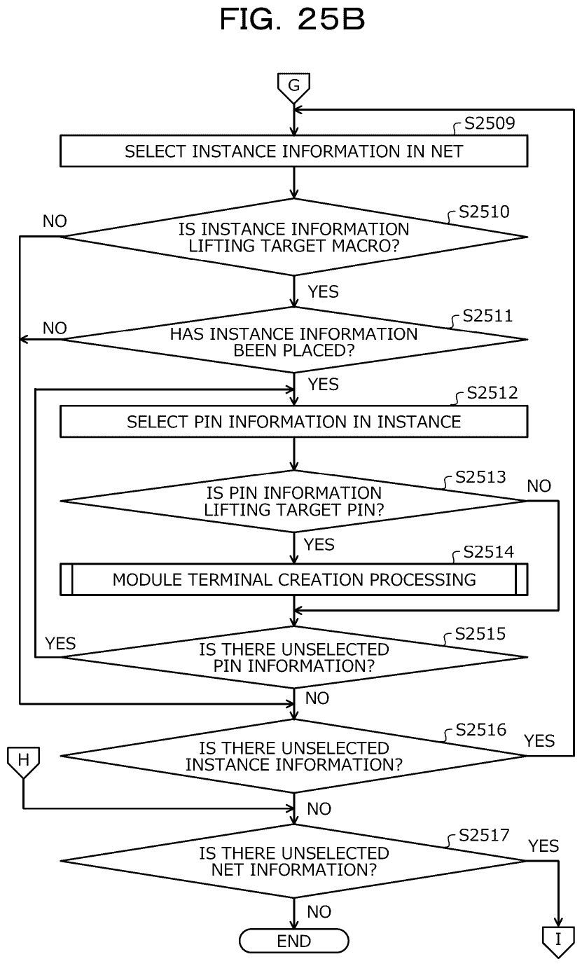

Next, a module terminal lifting processing procedure including an input of the control file will be described with reference to FIGS. 25A and 25B.

FIGS. 25A and 25B are flowcharts illustrating an example of the module terminal lifting processing procedure according to the second example. In the flowchart of FIG. 25A, first, the design support server 601 reads the layout database 630 (step S2501). Then, the design support server 601 reads the module terminal generation library Lb2 (step S2502).

Next, the design support server 601 reads an input control file (step S2503). Then, the design support server 601 sets default information of the control file to a target instance pin (step S2504). The default information of the control file corresponds to, for example, the default information 2110 illustrated in FIG. 21.

Next, the design support server 601 sets macro pin information of the control file to the target instance pin (step S2505). The macro pin information of the control file corresponds to, for example, the pin information in the macro setting information 2120 illustrated in FIG. 21.

Next, the design support server 601 sets instance pin information of the control file to the target instance pin (step S2506). The instance pin information of the control file corresponds to, for example, the pin information in the instance setting information 2130 illustrated in FIG. 21.

Then, the design support server 601 selects, with reference to the layout database 630, unselected net information that has not been selected among pieces of net information of a design target circuit (step S2507). Next, the design support server 601 determines whether or not the selected net information is an inter-hierarchy net (step S2508).

Here, in the case of not the inter-hierarchy net (step S2508: No), the design support server 601 proceeds to step S2517 indicated in FIG. 25B. On the other hand, in the case of the inter-hierarchy net (step S2508: Yes), the design support server 601 proceeds to step S2509 indicated in FIG. 25B.

In the flowchart of FIG. 25B, first, the design support server 601 selects, with reference to the layout database 630, unselected instance information that has not been selected among pieces of instance information in the net (step S2509).

Next, the design support server 601 determines whether or not the selected instance information is a lifting target macro (step S2510). Here, in the case of not the lifting target macro (step S2510: No), the design support server 601 proceeds to step S2516.

On the other hand, in the case of the lifting target macro (step S2510: Yes), the design support server 601 determines whether or not the selected instance information has been placed (step S2511). Here, in a case where the instance information has not been placed (step S2511: No), the design support server 601 proceeds to step S2516.

On the other hand, in a case where the instance information has been placed (S2511:Yes), the design support server 601 selects unselected pin information that has not been selected among pieces of pin information in the instance (step S2512). Then, the design support server 601 determines whether or not the selected pin information is a lifting target pin (step S2513).

Here, in the case of not the lifting target pin (step S2513: No), the design support server 601 proceeds to step S2515. On the other hand, in the case of the lifting target pin (step S2513: Yes), the design support server 601 executes module terminal creation processing (step S2514). Since a specific processing procedure of the module terminal creation processing is similar to the processing procedure illustrated in FIG. 17, illustration and description are omitted.

Next, the design support server 601 determines whether or not there is unselected pin information that has not been selected among the pieces of pin information in the instance (step S2515). Here, in a case where there is unselected pin information (step S2515: Yes), the design support server 601 returns to step S2512.

On the other hand, in a case where there is no unselected pin information (step S2515: No), the design support server 601 determines whether or not there is unselected instance information that has not been selected among the pieces of instance information in the net (step S2516). Here, in a case where there is unselected instance information (step S2516: Yes), the design support server 601 returns to step S2509.

On the other hand, in a case where there is no unselected instance information (step S2516: No), the design support server 601 determines whether or not there is unselected net information that has not been selected among the pieces of net information of the design target circuit (step S2517). Here, in a case where there is unselected net information (step S2517: Yes), the design support server 601 returns to step S2507 indicated in FIG. 25A.

On the other hand, in a case where there is no unselected net information (step S2517: No), the design support server 601 ends a series of processing according to the present flowchart.

As a result, the design support server 601 may create the module terminal according to the use and the wiring layer of the instance pin specified in the control file (the instance setting information, the macro setting information, or the default information).

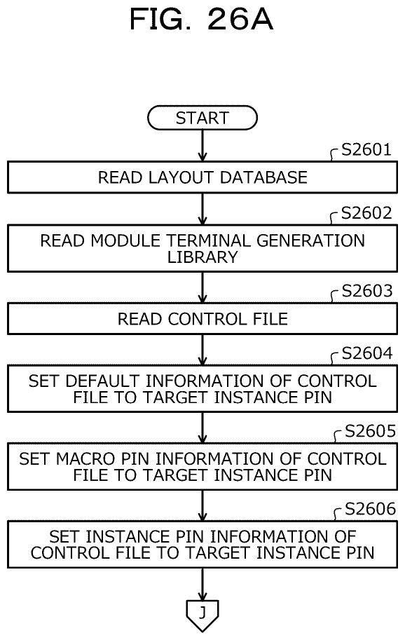

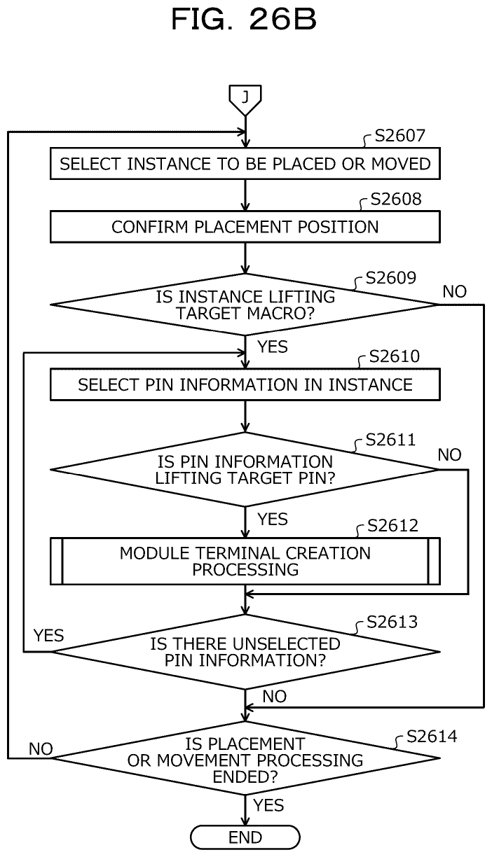

Next, a module terminal lifting processing procedure (interactive editor) including an input of the control file will be described with reference to FIGS. 26A and 26B.

FIGS. 26A and 26B are flowcharts illustrating an example of the module terminal lifting processing procedure (interactive editor) according to the second example. In the flowchart of FIG. 26A, first, the design support server 601 reads the layout database 630 (step S2601). Next, the design support server 601 reads the module terminal generation library Lb2 (step S2602).

Then, the design support server 601 reads an input control file (step S2603). Next, the design support server 601 sets default information of the control file to a target instance pin (step S2604). Next, the design support server 601 sets macro pin information of the control file to the target instance pin (step S2605). Next, the design support server 601 sets instance pin information of the control file to the target instance pin (step S2606).

Then, the design support server 601 selects an instance to be placed or moved by a user operation (step S2607). Next, the design support server 601 confirms a placement position of the selected instance by a user operation (step S2608).

Then, the design support server 601 determines whether or not the selected instance is a lifting target macro (step S2609). Here, in the case of not the lifting target macro (step S2609: No), the design support server 601 proceeds to step S2614.

On the other hand, in the case of the lifting target macro (S2609:Yes), the design support server 601 selects unselected pin information that has not been selected among pieces of pin information in the instance (step S2610). Then, the design support server 601 determines whether or not the selected pin information is a lifting target pin (step S2611).

Here, in the case of not the lifting target pin (step S2611: No), the design support server 601 proceeds to step S2613. On the other hand, in the case of the lifting target pin (step S2611: Yes), the design support server 601 executes module terminal creation processing (step S2612).

Note that since a specific processing procedure of the module terminal creation processing is similar to the processing procedure illustrated in FIG. 17, illustration and description are omitted.

Next, the design support server 601 determines whether or not there is unselected pin information that has not been selected among the pieces of pin information in the instance (step S2613). Here, in a case where there is unselected pin information (step S2613: Yes), the design support server 601 returns to step S2610.

On the other hand, in a case where there is no unselected pin information (step S2613: No), the design support server 601 determines whether or not placement or movement processing is ended (step S2614). Here, in a case where the placement or movement processing is not ended (step S2614: No), the design support server 601 returns to step S2607.

On the other hand, in a case where the placement or movement processing is ended (step S2614: Yes), the design support server 601 ends a series of processing according to the present flowchart.

As a result, the design support server 601 may create the module terminal according to the use and the wiring layer of the instance pin specified in the control file in the interactive manner (conversational manner) with a user.

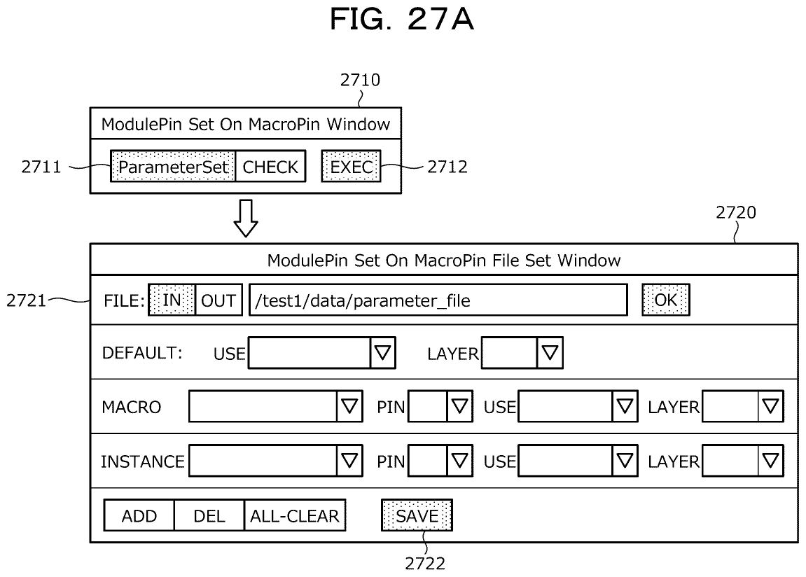

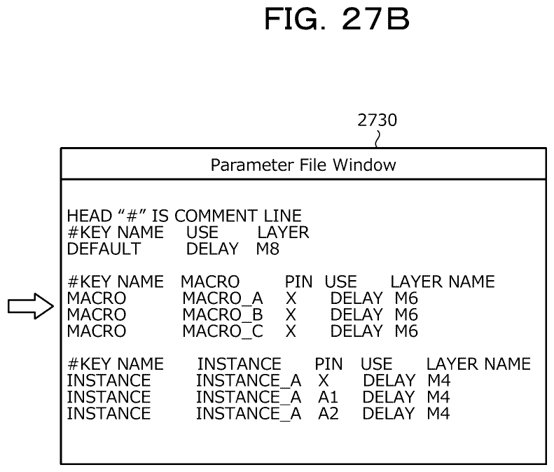

Here, various operation screens displayed on the client terminal 602 when the control file is input will be described with reference to FIGS. 27A and 27B. A user of the client terminal 602 is, for example, a designer of a design target circuit.

FIGS. 27A and 27B are explanatory diagrams illustrating an example of the operation screen related to the input of the control file. In FIG. 27A, ModulePin Set On MacroPin Window 2710 is an example of the operation screen displayed when the control file is input.

In the ModulePin Set On MacroPin Window 2710, when ParameterSet 2711 is selected and EXEC 2712 is pressed by an operation input from the user, parameter setting Window 2720 (ModulePin Set On MacroPin File Set Window) is displayed.

In the parameter setting Window 2720, when a file name (here, “/test1/data/parameter_file”) is input into a FILE field 2721 and “IN” and “OK” are pressed by an operation input from the user, the control file may be fetched into the inside.

When the control file is fetched, Parameter File Window 2730 as illustrated in FIG. 27B is displayed. As a result, the user may confirm content of the control file. Furthermore, in the parameter setting Window 2420, when SAVE 2722 is pressed by an operation input from the user, information may be reflected in the layout data.

### Third Example

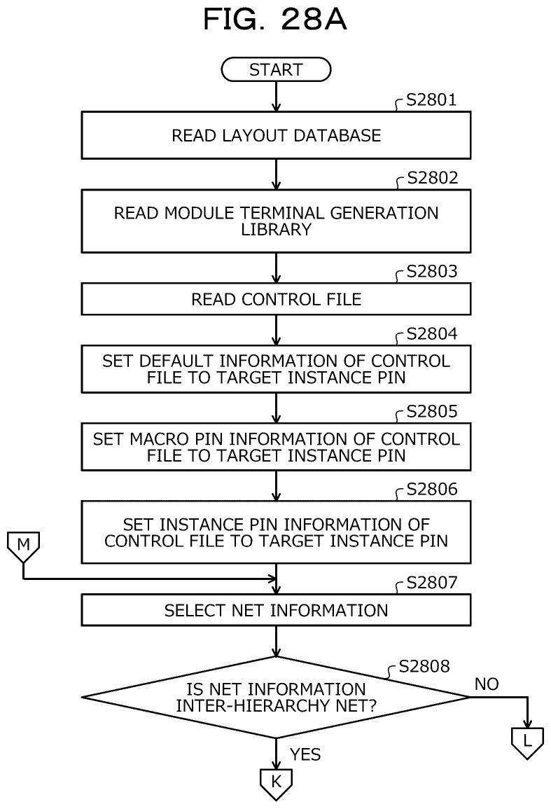

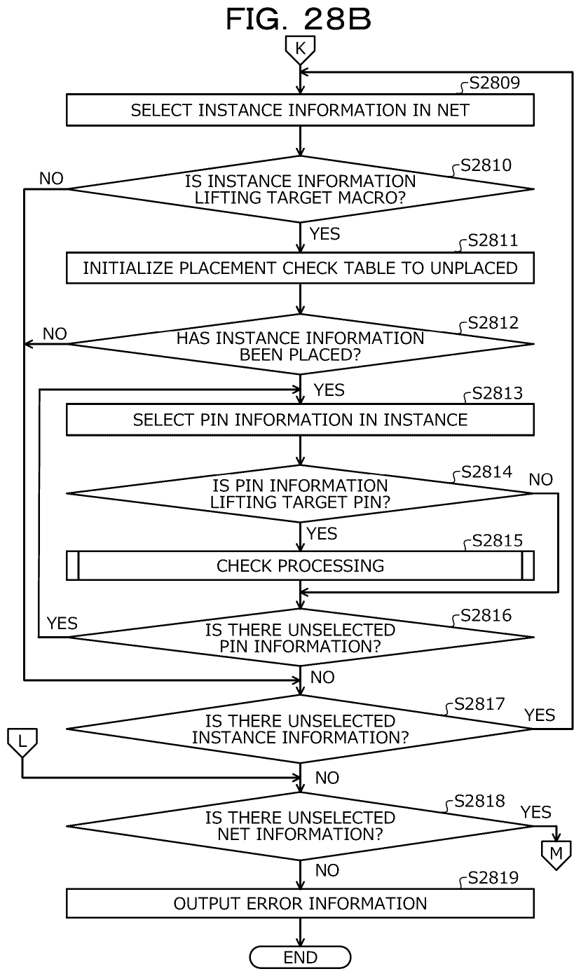

Next, a third example will be described. In the third example, a case will be described where whether a module terminal is correctly lifted is checked. First, a case will be described where whether or not a module terminal is correctly lifted is checked by a batch version program, with reference to FIGS. 28A and 28B.

FIGS. 28A and 28B are flowcharts illustrating an example of a module terminal check processing procedure according to the third example. In the flowchart of FIG. 28A, first, the design support server 601 reads the layout database 630 (step S2801). Then, the design support server 601 reads the module terminal generation library Lb2 (step S2802).

Next, the design support server 601 reads an input control file (step S2803). Then, the design support server 601 sets default information of the control file to a target instance pin (step S2804). Next, the design support server 601 sets macro pin information of the control file to the target instance pin (step S2805). Next, the design support server 601 sets instance pin information of the control file to the target instance pin (step S2806).

Then, the design support server 601 selects, with reference to the layout database 630, unselected net information that has not been selected among pieces of net information of a design target circuit (step S2807). Next, the design support server 601 determines whether or not the selected net information is an inter-hierarchy net (step S2808).

Here, in the case of not the inter-hierarchy net (step S2808: No), the design support server 601 proceeds to step S2818 indicated in FIG. 28B. On the other hand, in the case of the inter-hierarchy net (step S2808: Yes), the design support server 601 proceeds to step S2809 indicated in FIG. 28B.

In the flowchart of FIG. 28B, first, the design support server 601 selects, with reference to the layout database 630, unselected instance information that has not been selected among pieces of instance information in the net (step S2809).

Next, the design support server 601 determines whether or not the selected instance information is a lifting target macro (step S2810). Here, in the case of not the lifting target macro (step S2810: No), the design support server 601 proceeds to step S2817.

On the other hand, in the case of the lifting target macro (step S2810: Yes), the design support server 601 initializes a placement check table (not illustrated) to unplaced (step S2811). Then, the design support server 601 determines whether or not the selected instance information has been placed (step S2812). Here, in a case where the instance information has not been placed (step S2812: No), the design support server 601 proceeds to step S2817.

On the other hand, in a case where the instance information has been placed (S2812:Yes), the design support server 601 selects unselected pin information that has not been selected among pieces of pin information in the instance (step S2813). Then, the design support server 601 determines whether or not the selected pin information is a lifting target pin (step S2814).

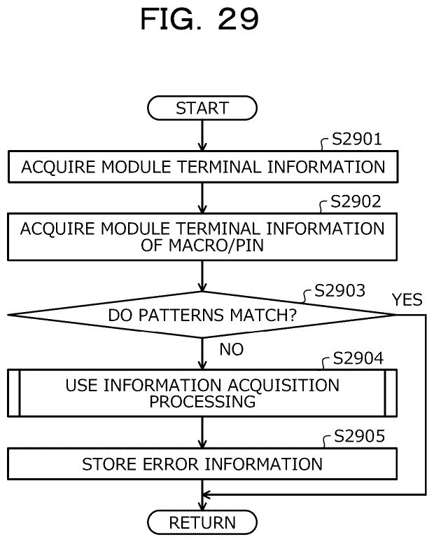

Here, in the case of not the lifting target pin (step S2814: No), the design support server 601 proceeds to step S2816. On the other hand, in the case of the lifting target pin (step S2814: Yes), the design support server 601 executes check processing (step S2815). A specific processing procedure of the check processing will be described later with reference to FIG. 29.

Next, the design support server 601 determines whether or not there is unselected pin information that has not been selected among the pieces of pin information in the instance (step S2816). Here, in a case where there is unselected pin information (step S2816: Yes), the design support server 601 returns to step S2813.

On the other hand, in a case where there is no unselected pin information (step S2816: No), the design support server 601 determines whether or not there is unselected instance information that has not been selected among the pieces of instance information in the net (step S2817). Here, in a case where there is unselected instance information (step S2817: Yes), the design support server 601 returns to step S2809.

On the other hand, in a case where there is no unselected instance information (step S2817: No), the design support server 601 determines whether or not there is unselected net information that has not been selected among the pieces of net information of the design target circuit (step S2818). Here, in a case where there is unselected net information (step S2818: Yes), the design support server 601 returns to step S2807 indicated in FIG. 28A.

On the other hand, in a case where there is no unselected net information (step S2818: No), the design support server 601 outputs error information (step S2819), and ends a series of processing according to the present flowchart.

Next, a specific processing procedure of the check processing in step S2815 will be described with reference to FIG. 29.

FIG. 29 is a flowchart illustrating an example of the specific processing procedure of the check processing. In the flowchart of FIG. 29, first, the design support server 601 acquires module terminal information based on information of the module terminal generation library Lb2 of a corresponding macro/pin defined in the control file read in step S2803 (step S2901).

The module terminal information is information of a module terminal (for example, a placement pattern of terminals including the module terminal) created by module terminal creation processing of the design support server 601 for the corresponding macro/pin. Note that since specific processing content for acquiring the module terminal information is similar to the module terminal creation processing procedure illustrated in FIG. 17, illustration and description are omitted.

Next, the design support server 601 acquires the module terminal information of a macro/pin (step S2902). The module terminal information is, for example, information of a module terminal of the macro/pin placed in physical design of the design target circuit, and is specified from the layout database 630.

Then, the design support server 601 determines whether or not a pattern of the module terminal information acquired in step S2901 matches a pattern of the module terminal information acquired in step S2902 (step S2903). Here, in a case where the patterns match (step S2903: Yes), the design support server 601 returns to the step in which the check processing has been called.

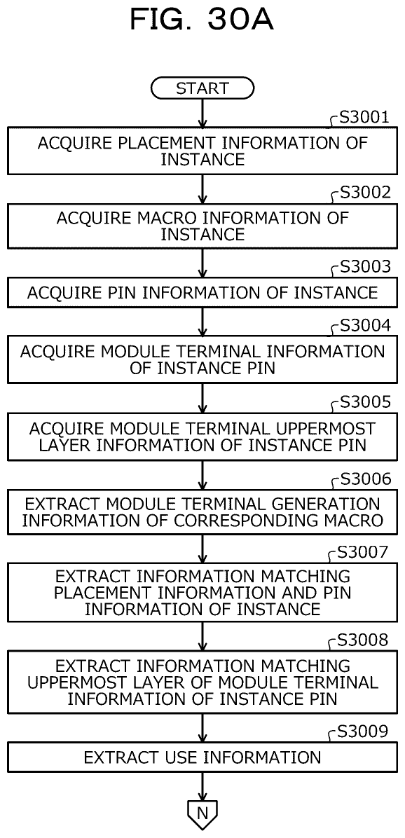

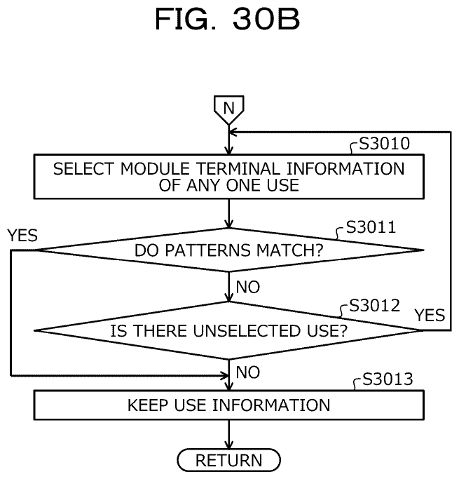

On the other hand, in a case where the patterns do not match (step S2903: No), the design support server 601 executes use information acquisition processing (step S2904). The use information acquisition processing is processing of acquiring information regarding a use and a wiring layer defined in the module terminal generation library Lb2 from the module terminal information of the macro/pin. A specific processing procedure of the use information acquisition processing will be described later with reference to FIGS. 30A and 30B.

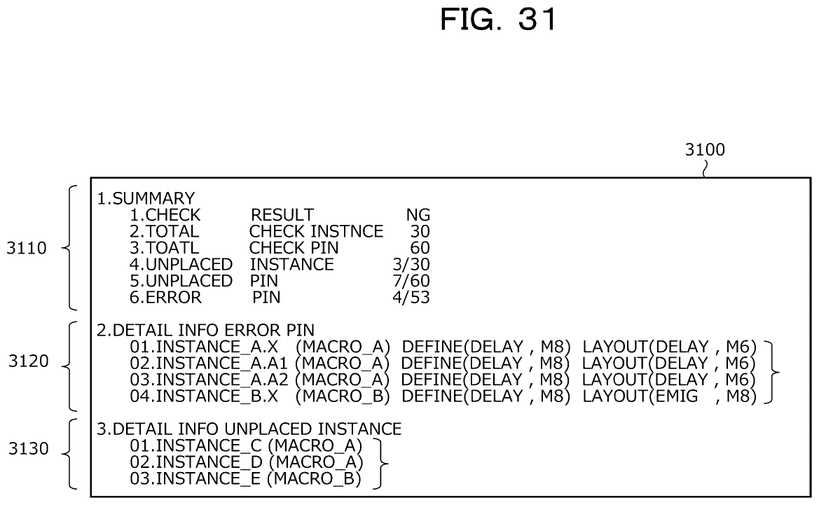

Then, the design support server 601 stores error information (step S2905), and returns to the step in which the check processing has been called. The error information includes, for example, information for specifying a macro/pin whose pattern does not match in step S2903. The error information corresponds to, for example, a check result 3100 illustrated in FIG. 31 to be described later.

Next, a specific processing procedure of the use information acquisition processing in step S2904 will be described with reference to FIGS. 30A and 30B.

FIGS. 30A and 30B are flowcharts illustrating an example of the specific processing procedure of the use information acquisition processing. In FIG. 30A, first, the design support server 601 acquires placement information of the instance (step S3001). Note that the instance is the instance specified from the instance information selected in step S2809 indicated in FIG. 28B.

Next, the design support server 601 acquires macro information of the instance (step S3002). Next, the design support server 601 acquires pin information of the instance (step S3003). Then, the design support server 601 acquires module terminal information of an instance pin (step S3004).

Next, the design support server 601 acquires module terminal uppermost layer information of the instance pin (step S3005). The module terminal uppermost layer information is information for specifying an uppermost layer in which a module terminal is placed. Then, the design support server 601 extracts, from the module terminal generation library Lb2, module terminal generation information of a corresponding macro (step S3006).

Next, the design support server 601 extracts information matching the acquired placement information and pin information of the instance from the extracted module terminal generation information (step S3007). Then, the design support server 601 extracts information matching an uppermost layer of the acquired module terminal information of the instance pin from the information extracted in step S3007 (step S3008).

Next, the design support server 601 extracts use information from the information extracted in step S3008 (step S3009), and proceeds to step S3010 indicated in FIG. 30B.

In the flowchart of FIG. 30B, first, the design support server 601 selects module terminal information of any one use from the use information extracted in step S3009 (step S3010). Then, the design support server 601 determines whether or not a pattern of the module terminal information acquired in step S3004 matches a pattern of the selected module terminal information (step S3011).

Here, in a case where the patterns match (step S3011: Yes), the design support server 601 proceeds to step S3013. On the other hand, in a case where the patterns do not match (step S3011: No), the design support server 601 determines whether or not there is module terminal information of an unselected use that has not been selected from the extracted use information (step S3012).

Here, in a case where there is module terminal information of an unselected use (step S3012: Yes), the design support server 601 returns to step S3010. On the other hand, in a case where there is no module terminal information of an unselected use (step S3012: No), the design support server 601 keeps the use information whose module terminal information matches in step S3011 (step S3013), and returns to the step in which the use information acquisition processing has been called. The kept use information may be included in, for example, the error information stored in step S2905 indicated in FIG. 29.

FIG. 31 is an explanatory diagram illustrating a specific example of the check result. In FIG. 31, the check result 3100 includes SUMMARY information 3110, error instance pin detailed information 3120, and non-placement information 3130. The SUMMARY information 3110 includes a check result, the number of check instances, the number of check instance pins, the number of unplaced instances, the number of unplaced instance pins, and the number of error instance pins.

The check result indicates a result of the check processing (“OK” or “NG”). The number of check instances indicates the number of instances that have been checked. The number of check instance pins indicates the number of instance pins that have been checked. The number of unplaced instances indicates the number of instances that have not been placed (the number of unplaced instances/the total number of instances). The number of unplaced instance pins indicates the number of instance pins that have not been placed (the number of unplaced instance pins/the total number of instance pins). The number of error instance pins indicates the number of instance pins with an error (the number of error instance pins/the number of placed instance pins).

The error instance pin detailed information 3120 indicates detailed information of an error instance pin. The error instance pin detailed information 3120 includes (definition information (use information and wiring layer information)) and (layout information (use information and wiring layer information)) of the error instance pin.

According to the error instance pin detailed information 3120, for example, for an instance pin A.X of the macro A, it may be seen that a wiring layer is different between definition information (control file) and layout information. Furthermore, for an instance pin B.X of a macro B, it may be seen that a use is different between definition information (control file) and layout information.

The non-placement information 3130 indicates an instance that has not been placed. According to the non-placement information 3130, it may be seen that instances C and D of the macro A have not been placed and an instance E of the macro B has not been placed.

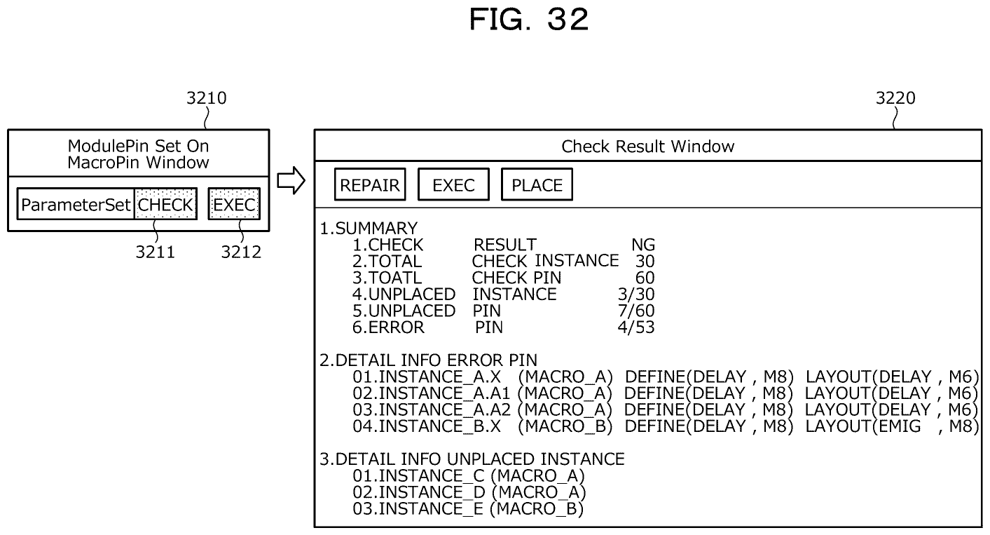

Here, various operation screens displayed on the client terminal 602 when whether or not the module terminal is correctly lifted is checked will be described with reference to FIG. 32. A user of the client terminal 602 is, for example, a designer of a design target circuit.

FIG. 32 is an explanatory diagram illustrating an example of the operation screen related to the module terminal check. In FIG. 32, ModulePin Set On MacroPin Window 3210 is an example of the operation screen displayed when the module terminal is checked.

In the ModulePin Set On MacroPin Window 3210, when CHECK 3211 is selected and EXEC 3212 is pressed by an operation input from the user, check result Window 3220 (Check Result Window) is displayed. In the check result Window 3220, for example, the check result 3100 illustrated in FIG. 31 is displayed.

As a result, the user (designer) may check whether there is a difference between definition information (control file) and layout information. For example, in a case where content of the control file is corrected or the control file is created again, the user (designer) may check whether or not the user (designer) has forgotten to perform physical design (re-layout) again.

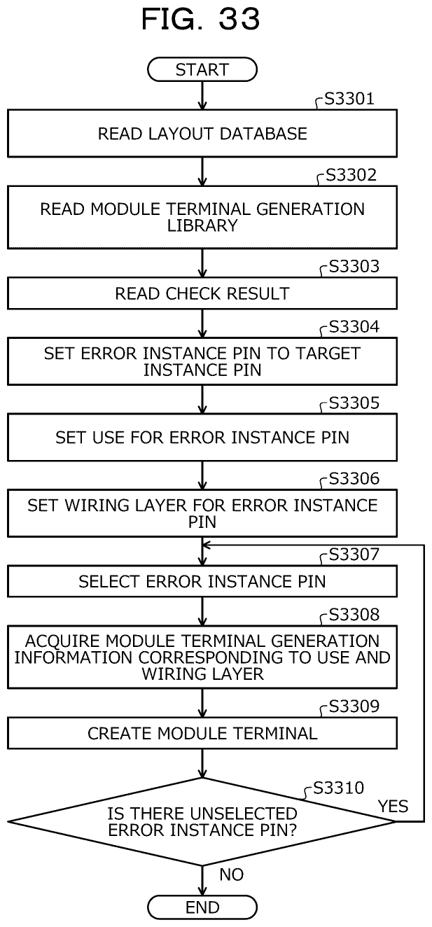

In a case where an error is detected as a result of checking whether the module terminal is correctly lifted, a correction is made. Here, a case will be described where an error portion is corrected. First, a case will be described where the error portion is corrected by a batch version program, with reference to FIG. 33.

FIG. 33 is a flowchart illustrating an example of an error portion correction processing procedure according to the third example. In the flowchart of FIG. 33, first, the design support server 601 reads the layout database 630 (step S3301). Then, the design support server 601 reads the module terminal generation library Lb2 (step S3302).

Next, the design support server 601 reads a check result of a lifting module terminal (step S3303). The check result of the lifting module terminal is, for example, the check result 3100 illustrated in FIG. 31. Then, the design support server 601 sets, with reference to the check result, an error instance pin to a target instance pin (step S3304).

Next, the design support server 601 sets a use for the error instance pin (step S3305). The use is specified from, for example, the check result read in step S3303. Next, the design support server 601 sets a wiring layer for the error instance pin (step S3306). The wiring layer is specified from, for example, the check result read in step S3303.

Then, the design support server 601 selects an unselected error instance pin that has not been selected among target instance pins (step S3307). Next, the design support server 601 acquires module terminal generation information corresponding to the use and the wiring layer set for the error instance pin from the module terminal generation library Lb2 (step S3308).

Then, the design support server 601 creates a module terminal for the error instance pin based on the acquired module terminal generation information (step S3309). Next, the design support server 601 determines whether or not there is an unselected error instance pin that has not been selected among the target instance pins (step S3310).

Here, in a case where there is an error instance pin (step S3310: Yes), the design support server 601 returns to step S3307. On the other hand, in a case where there is no error instance pin (step S3310: No), the design support server 601 ends a series of processing according to the present flowchart.

As a result, the design support server 601 may automatically correct the error portion where the module terminal is not correctly lifted.

Next, a case will be described where an error portion or the like is corrected with an interactive editor. Here, various operation screens displayed on the client terminal 602 when the error portion or the like is corrected with the interactive editor will be described. A user of the client terminal 602 is, for example, a designer of a design target circuit.

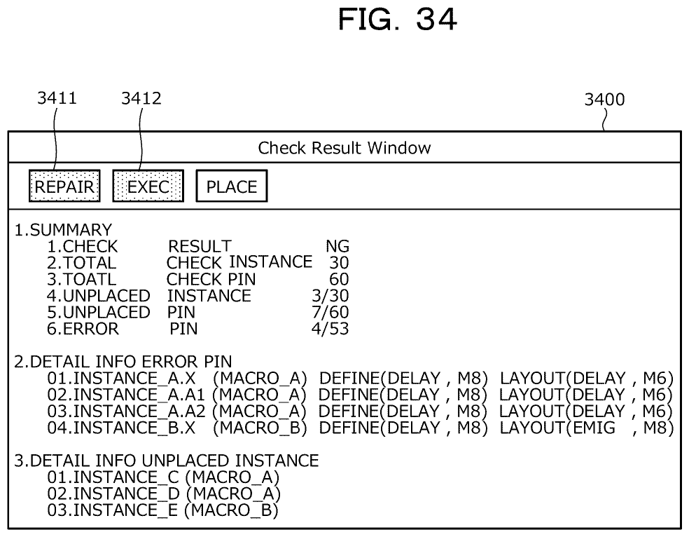

FIG. 34 is an explanatory diagram illustrating an example of the operation screen related to the correction of the error portion. In FIG. 34, check result Window 3400 (Check Result Window) includes a check result as to whether the module terminal is correctly lifted.

In the check result Window 3400, when REPAIR 3411 is selected and EXEC 3412 is pressed by an operation input from the user, the design support server 601 executes the error portion correction processing (see FIG. 33). When the error portion correction processing is completed, for example, the module terminal check processing (see FIGS. 28A and 28B) is executed again, and a check result thereof is displayed in the check result Window 3400.

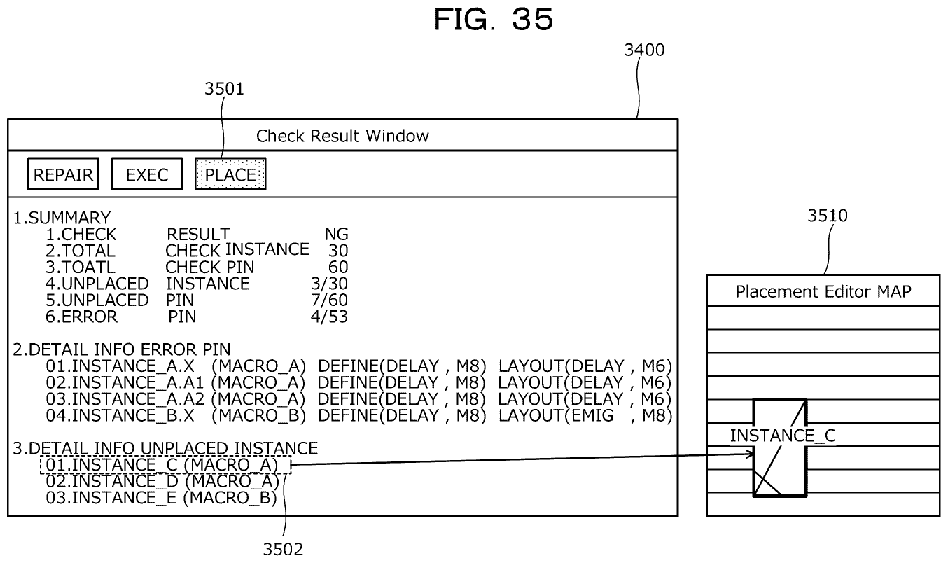

FIG. 35 is an explanatory diagram illustrating an example of an operation screen related to correction of an unplaced portion. In FIG. 35, the check result Window 3400 (Check Result Window) includes the check result as to whether the module terminal is correctly lifted.

In the check result Window 3400, when PLACE 3501 is selected by an operation input from the user, an instance to be placed may be selected from “3. DETAIL INFO UNPLACED INSTANCE” in the check result. Here, it is assumed that the instance C of the macro A is selected (a portion of a reference sign 3502 in FIG. 35).

In this case, Placement Editor MAP 3510 is displayed, and a placement work of the instance C of the macro A may be performed on a screen. For example, in the Placement Editor MAP 3510, the instance C may be placed at an optional position by an operation input from the user.

As described above, according to the design support server 601 according to the embodiment, it is possible to create a temporary macro for each placement position included in a plurality of placement positions where a target macro having a multilayer structure placed in a design target circuit may be placed according to a power supply structure of the design target circuit. The temporary macro represents a placement pattern of terminals of each layer in the target macro according to the placement position. The target macro is, for example, a macro coupled to a clock net among macros in the design target circuit. Then, according to the design support server 601, it is possible to extract, based on a result of comparison between placement patterns of the created temporary macros, a common pattern representing a portion common among the temporary macros, extract a difference pattern representing a difference from the extracted common pattern among the created temporary macros for each placement position, and register the common pattern and the extracted difference pattern for each placement position in the macro library 620 in association with the target macro.

As a result, the design support server 601 may form a portion common among the temporary macros for the respective placement positions where placement is possible according to the power supply structure of the design target circuit into a library as a formal macro. Furthermore, the design support server 601 may componentize and register the difference patterns between the temporary macros for the respective placement positions and the common pattern. For example, the design support server 601 may provide up to a portion not affected by the placement position in the target macro as the physical macro library Lb1, and may provide a non-common portion as the module terminal generation library Lb2.

Furthermore, according to the design support server 601, it is possible to create, when the target macro is placed at a first placement position of the plurality of placement positions at the time of the physical design of the design target circuit, a module terminal for a lifting target terminal in the target macro based on the common pattern and a difference pattern corresponding to the first placement position, with reference to the macro library 620. The lifting target terminal is a terminal of a wiring layer (uppermost layer for the terminal) to which wiring with the outside is coupled.

As a result, the design support server 601 may facilitate designing of a circuit including the module terminal. For example, the design support server 601 may create a placement pattern of terminals on a side of layout from the common pattern registered as the formal macro and a difference pattern according to an actual placement position, and may appropriately generate the module terminal for inter-hierarchy coupling in LSI hierarchical design.

Furthermore, according to the design support server 601, it is possible to create the temporary macro for each combination of each use of a plurality of uses applicable to the target macro and each placement position of the plurality of placement positions. Furthermore, according to the design support server 601, it is possible to extract, based on a result of comparison between placement patterns of the created temporary macros, a common pattern representing a portion common among the temporary macros, and extract a difference pattern representing a difference from the extracted common pattern among the created temporary macros for each combination of the user and the placement position. Then, according to the design support server 601, it is possible to register the common pattern and the difference pattern for each combination of the use and the placement position in the macro library 620 in association with the target macro.

As a result, the design support server 601 may create a library that may select a terminal structure according to an application use on the assumption that the macro is used for various uses such as antenna error suppression, electromigration suppression, and delay suppression.

Furthermore, according to the design support server 601, it is possible to create, when the target macro is placed at the first placement position of the plurality of placement positions in a first use of the plurality of uses, the module terminal based on the common pattern and a difference pattern corresponding to a combination of the first use and the first placement position, with reference to the macro library 620.

As a result, the design support server 601 may enable creation of a placement pattern of the terminal structure in consideration of the application use, and may generate an optimal module terminal according to the placement position and the use of the macro. Furthermore, the design support server 601 may enhance flexibility at the time of design and improve user convenience.

Furthermore, according to the design support server 601, it is possible to create the temporary macro for each combination of each wiring layer of a plurality of wiring layers for external coupling applicable to the target macro and each placement position of the plurality of placement positions. Furthermore, according to the design support server 601, it is possible to extract, based on a result of comparison between placement patterns of the created temporary macros, a common pattern representing a portion common among the temporary macros, and extract a difference pattern representing a difference from the extracted common pattern among the created temporary macros for each combination of the wiring layer and the placement position. Then, according to the design support server 601, it is possible to register the common pattern and the difference pattern for each combination of the wiring layer and the placement position in the macro library 620 in association with the target macro.

As a result, the design support server 601 may create a library that may select a terminal structure according to an application wiring layer on the assumption that various wiring layers are applied according to a coupling destination circuit (a circuit of another hierarchy).

Furthermore, according to the design support server 601, it is possible to create, when the target macro is placed at the first placement position of the plurality of placement positions in a first wiring layer of the plurality of wiring layers, the module terminal based on the common pattern and a difference pattern corresponding to a combination of the first wiring layer and the first placement position, with reference to the macro library 620.

As a result, the design support server 601 may enable creation of a placement pattern of a terminal structure in consideration of an application wiring layer, and may generate an optimal module terminal according to the placement position and the wiring layer of the macro. Furthermore, the design support server 601 may enhance flexibility at the time of design and improve user convenience.

Furthermore, according to the design support server 601, it is possible to accept an input of a control file (for example, the control file 2100) in which the first use to be applied to the target macro among the plurality of uses is defined. Then, according to the design support server 601, it is possible to create, when the target macro is placed at the first placement position at the time of the physical design of the design target circuit, the module terminal based on a difference pattern corresponding to a combination of the first use defined in the input control file and the first placement position, with reference to the macro library 620.

As a result, the design support server 601 may enable specification of the use to be applied to the target macro. For example, a designer may optionally specify the use to be applied to the target macro by defining the use in the control file.

Furthermore, according to the design support server 601, it is possible to accept an input of a control file (for example, the control file 2100) in which the first wiring layer to be applied to the target macro among the plurality of wiring layers is defined. Then, according to the design support server 601, it is possible to create, when the target macro is placed at the first placement position at the time of the physical design of the design target circuit, the module terminal based on a difference pattern corresponding to a combination of the first wiring layer defined in the input control file and the first placement position, with reference to the macro library 620.

As a result, the design support server 601 may enable specification of the wiring layer to be applied to the target macro. For example, the designer may optionally specify the wiring layer to be applied to the target macro by defining the wiring layer in the control file. For example, in a case where up to the M7 layer is used in a lower hierarchy and the M8 layer and subsequent layers are used in an uppermost hierarchy, a designer of the lower hierarchy specifies the wiring layer to be applied to the target macro as the “M8 layer”.

From these, even in a case where the module terminal is created in an upper layer, the design support server 601 may appropriately generate the module terminal on the side of the layout so as to satisfy strict pattern restriction up to the module terminal without providing the macro for each placement position (physical macro library Lb1) or confirming the placement at the time of logic design. For example, by lifting the module terminal, the design support server 601 may provide wiring in view of coupling information of entire nets in the uppermost hierarchy or the like, and may perform, for example, a wiring pattern in consideration of the entire nets such as the clock net. Furthermore, the design support server 601 may shorten a design period of the LSI by facilitating designing of the lower hierarchy in the LSI hierarchical design.

Note that the module terminal design method described in the present embodiment may be implemented by executing a program prepared in advance in a computer such as a personal computer or a workstation. The present module terminal design program is recorded in a computer-readable recording medium such as a hard disk, a flexible disk, a CD-ROM, a DVD, or a USB memory, and is read from the recording medium to be executed by the computer. Furthermore, the present module terminal design program may be distributed via a network such as the Internet.

Furthermore, the information processing device 101 (design support server 601) described in the present embodiment may also be implemented by a special-purpose integrated circuit (IC) such as a standard cell or a structured application specific integrated circuit (ASIC) or a programmable logic device (PLD) such as a field-programmable gate array (FPGA).

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a module terminal design program for causing a computer to execute processing comprising:
creating, for each placement position included in a plurality of placement positions where a target macro that has a multilayer structure placed in a design target circuit is placeable according to a power supply structure of the design target circuit, a temporary macro that represents a placement pattern of terminals of each layer of the target macro;
extracting, based on a result of comparison between placement patterns of the created temporary macros, a common pattern that represents a portion common among the temporary macros;
extracting a difference pattern that represents a difference from the extracted common pattern among the created temporary macros for each placement position;
registering the common pattern and the extracted difference pattern for each placement position in a library in association with the target macro; and
creating, when the target macro is placed at any one placement position of the plurality of placement positions at a time of physical design of the design target circuit, a module terminal for a lifting target terminal in the target macro based on the common pattern and a difference pattern that corresponds to the any one placement position, with reference to the library.

2. The non-transitory computer-readable recording medium according to claim 1, for causing the computer to further execute processing comprising:
creating the temporary macro for each combination of each use of a plurality of uses applicable to the target macro and each placement position of the plurality of placement positions;
extracting, based on a result of comparison between placement patterns of the created temporary macros, a common pattern that represents a portion common among the temporary macros;
extracting a difference pattern that represents a difference from the extracted common pattern among the created temporary macros for each combination;
registering the common pattern and the extracted difference pattern for each combination in the library in association with the target macro; and
creating, when the target macro is placed at any one placement position among the plurality of placement positions in any one use of the plurality of uses, the module terminal based on a difference pattern that corresponds to a combination of the any one use and the any one placement position, with reference to the library.

3. The non-transitory computer-readable recording medium according to claim 1, for causing the computer to further execute processing comprising:
creating the temporary macro for each combination of each wiring layer of a plurality of wiring layers for external coupling applicable to the target macro and each placement position of the plurality of placement positions;
extracting, based on a result of comparison between placement patterns of the created temporary macros, a common pattern that represents a portion common among the temporary macros;
extracting a difference pattern that represents a difference from the extracted common pattern among the created temporary macros for each combination;
registering the common pattern and the extracted difference pattern for each combination in the library in association with the target macro; and
creating, when the target macro is placed at any one placement position among the plurality of placement positions in any one wiring layer of the plurality of wiring layers, the module terminal based on the common pattern and a difference pattern that corresponds to a combination of the any one wiring layer and the any one placement position, with reference to the library.

4. The non-transitory computer-readable recording medium according to claim 1, wherein the target macro is a macro coupled to a net that includes a clock net among macros in the design target circuit.

5. The non-transitory computer-readable recording medium according to claim 1, wherein the module terminal is a module terminal that has the same layer, the same shape, and the same placement position as a layer, a shape, and a placement position of the lifting target terminal.

6. The non-transitory computer-readable recording medium according to claim 1, wherein the lifting target terminal is a terminal of a wiring layer to which wiring between the target macro and the outside is coupled.

7. The non-transitory computer-readable recording medium according to claim 2, for causing the computer to further execute processing of accepting an input of a control file in which a use to be applied to the target macro among the plurality of uses is defined,
wherein, in the processing of creating the module terminal,
when the target macro is placed at the any one placement position, the module terminal is created based on a difference pattern that corresponds to a combination of the use defined in the input control file and the any one placement position, with reference to the library.

8. The non-transitory computer-readable recording medium according to claim 3, for causing the computer to further execute processing of accepting an input of a control file in which a wiring layer to be applied to the target macro among the plurality of wiring layers is defined,
wherein, in the processing of creating the module terminal,
when the target macro is placed at the any one placement position, the module terminal is created based on a difference pattern that corresponds to a combination of the wiring layer defined in the input control file and the any one placement position, with reference to the library.

9. A module terminal design method for causing a computer to execute processing comprising:
creating, for each placement position included in a plurality of placement positions where a target macro that has a multilayer structure placed in a design target circuit is placeable according to a power supply structure of the design target circuit, a temporary macro that represents a placement pattern of terminals of each layer of the target macro;
extracting, based on a result of comparison between placement patterns of the created temporary macros, a common pattern that represents a portion common among the temporary macros;
extracting a difference pattern that represents a difference from the extracted common pattern among the created temporary macros for each placement position;
registering the common pattern and the extracted difference pattern for each placement position in a library in association with the target macro; and
creating, when the target macro is placed at any one placement position of the plurality of placement positions at a time of physical design of the design target circuit, a module terminal for a lifting target terminal in the target macro based on the common pattern and a difference pattern that corresponds to the any one placement position, with reference to the library.

10. An information processing device comprising:
a memory; and
a processor coupled to the memory and configured to:
create, for each placement position included in a plurality of placement positions where a target macro that has a multilayer structure placed in a design target circuit is placeable according to a power supply structure of the design target circuit, a temporary macro that represents a placement pattern of terminals of each layer of the target macro;
extract, based on a result of comparison between placement patterns of the created temporary macros, a common pattern that represents a portion common among the temporary macros;
extract a difference pattern that represents a difference from the extracted common pattern among the created temporary macros for each placement position;
register the common pattern and the extracted difference pattern for each placement position in a library in association with the target macro; and
create, when the target macro is placed at any one placement position of the plurality of placement positions at a time of physical design of the design target circuit, a module terminal for a lifting target terminal in the target macro based on the common pattern and a difference pattern that corresponds to the any one placement position, with reference to the library.
